(19) United States
(12) Patent Application Publication
(10) Pub. No.: US 2008/0123577 A1
(43) Pub. Date: May 29, 2008

(54) METHOD AND APPARATUS FOR PROVIDING POWER SAVE MANAGEMENT

(76) Inventors: Mikko Jaakkola, Lempaala (FI); Jari Jokela, Ylojarvi (FI)

Correspondence Address: DITTHAVONG MORI & STEINER, P.C., 918 Prince St., Alexandria, VA, 22314, US

(21) Appl. No.: 11/936,487

(22) Filed: Nov. 7, 2007

Related U.S. Application Data
(60) Provisional application No. 60/864,691, filed on Nov. 7, 2006.

(51) Int. Cl. G08C 17/00; H04Q 7/24

(52) U.S. Cl. 370/311; 370/338

(57) ABSTRACT

An approach is provided for an approach to manage a power saving scheme for multicast or broadcast services. A signal is received from a terminal configured to utilize a power-save mechanism. State of a multicast or broadcast group is determined for the terminal based on the signal. The power-save mechanism of the terminal is bypassed if the state is determined to be active to permit transmission of data, which is designated for the multicast or the broadcast group, to the terminal.

### RELATED APPLICATIONS

This application claims the benefit of the earlier filing date under 35 U.S.C. §119(e) of U.S. Provisional Application Ser. No. 60/864,691 filed Nov. 7, 2006, entitled “Method and Apparatus For Providing Power Save Management,” the entirety of which is incorporated herein by reference.

### BACKGROUND

Radio communication systems, such as a Wireless Local Area Network (WLAN) (e.g., Institute of Electrical and Electronic Engineers (IEEE) 802.11), provide users with the convenience of mobility along with a rich set of services and features. This convenience has spawned significant adoption by an ever growing number of consumers as an accepted mode of communication for business and personal uses. To promote greater adoption, the telecommunication industry, from manufacturers to service providers, has agreed at great expense and effort to develop standards for communication protocols that underlie the various services and features. One key area of effort involves increasing operating time for devices that rely on battery power for mobility. Unfortunately, power saving mechanisms can result in inefficient operations, e.g., reduction in throughput.

### SOME EXEMPLARY EMBODIMENTS

Therefore, there is a need for an approach to provide an efficient power saving scheme for a communication system.

According to one embodiment of the invention, a method comprises receiving a signal from a terminal configured to utilize a power-save mechanism. The method also comprises determining state of a multicast or broadcast group for the terminal based on the signal. Further, the method comprises bypassing the power-save mechanism of the terminal if the state is determined to be active to permit transmission of data, which is designated for the multicast or the broadcast group, to the terminal.

According to another embodiment of the invention, an apparatus comprises a module configured to receive a signal from a terminal configured to utilize a power-save mechanism, and to determine state of a multicast or broadcast group for the terminal based on the signal. The module is further configured to bypass the power-save mechanism of the terminal if the state is determined to be active to permit transmission of data, which is designated for the multicast or the broadcast group, to the terminal.

According to another embodiment of the invention, a method comprises generating a signal specifying an active state associated with a multicast or broadcast group, the signal being transmitted to an access point. The method also comprises avoiding entry into a power-saving mode based on the generated signal or another signal generated by any member of the group specifying an active state for the group.

According to yet another embodiment of the invention, an apparatus comprises a processor configured to generate a signal specifying an active state associated with a multicast or broadcast group, the signal being transmitted to an access point. Entry into a power-saving mode is avoided based on the generated signal or another signal generated by any member of the group specifying an active state for the group.

Still other aspects, features, and advantages of the invention are readily apparent from the following detailed description, simply by illustrating a number of particular embodiments and implementations, including the best mode contemplated for carrying out the invention. The invention is also capable of other and different embodiments, and its several details can be modified in various obvious respects, all without departing from the spirit and scope of the invention. Accordingly, the drawings and description are to be regarded as illustrative in nature, and not as restrictive.

### BRIEF DESCRIPTION OF THE DRAWINGS

The embodiments of the invention are illustrated by way of example, and not by way of limitation, in the figures of the accompanying drawings:

FIGS. 1A and 1B are diagrams, respectively, of a wireless access point and a wireless terminal capable of providing multicast active-station power-save optimization, in accordance with various embodiments of the invention;

FIG. 2 is a flowchart of a process for managing power saving mechanisms, in accordance with various embodiments of the invention;

FIGS. 3A-3I are diagrams of a communication architecture and associated message formats for providing multicast and broadcast services, in accordance with an embodiment of the invention;

FIG. 4 is a diagram of hardware that can be used to implement an embodiment of the invention;

FIGS. 5A and 5B are diagrams of different cellular mobile phone systems capable of supporting various embodiments of the invention;

FIG. 6 is a diagram of exemplary components of a mobile station capable of operating in the systems of FIGS. 5A and 5B, according to an embodiment of the invention; and

FIG. 7 is a diagram of an enterprise network capable of supporting the processes described herein, according to an embodiment of the invention.

### DESCRIPTION OF PREFERRED EMBODIMENTS

An apparatus, method, and software for managing power saving mechanisms in a communication network are disclosed. In the following description, for the purposes of explanation, numerous specific details are set forth in order to provide a thorough understanding of the embodiments of the invention. It is apparent, however, to one skilled in the art that the embodiments of the invention may be practiced without these specific details or with an equivalent arrangement. In other instances, well-known structures and devices are shown in block diagram form in order to avoid unnecessarily obscuring the embodiments of the invention.

Although the embodiments of the invention are discussed with respect to a wireless local area network (WLAN) compliant with the Institute of Electrical and Electronic Engineers (IEEE) 802.11 architecture, it is recognized by one of ordinary skill in the art that the embodiments of the inventions have applicability to any type of radio communication system and equivalent protocols.

The invention, according to certain embodiments, provides a power saving optimization scheme for multicast/broadcast services over a wireless network. A more detailed description of the broadcast multicast processing is provided in IEEE P802.11v/D1.02, entitled “Telecommunications and Information Exchange between Systems-Local and Metropolitan Area Networks: Part 11: Wireless LAN Medium Access Control (MAC) and Physical Layer (PHY) specifications: Amendment 9: Wireless Network Management,” which is incorporated herein by reference in its entirety. (hereinafter denoted by “IEEE P802.11v”).

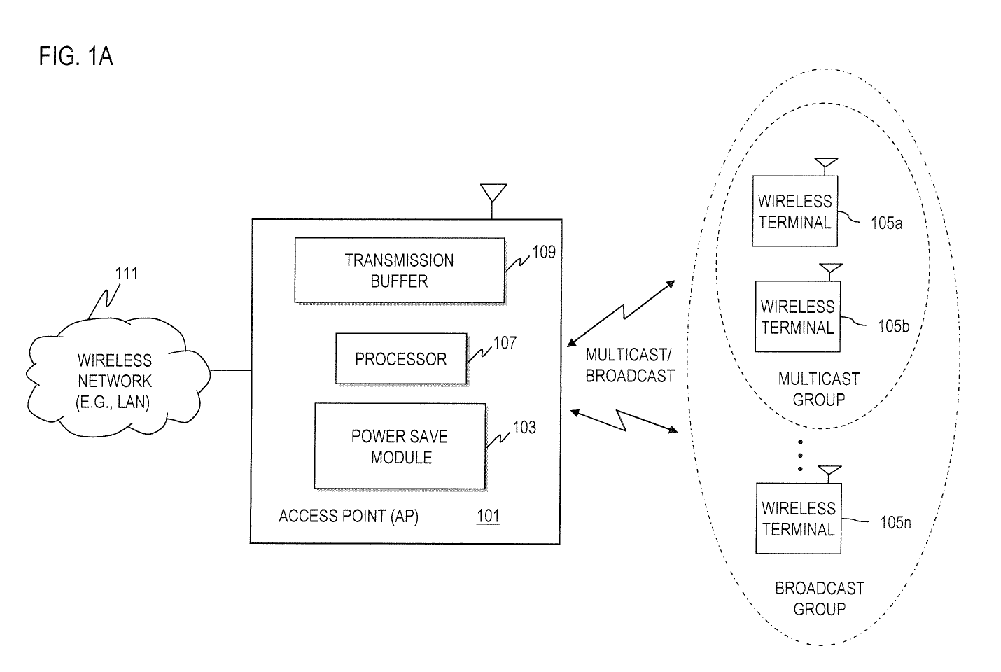

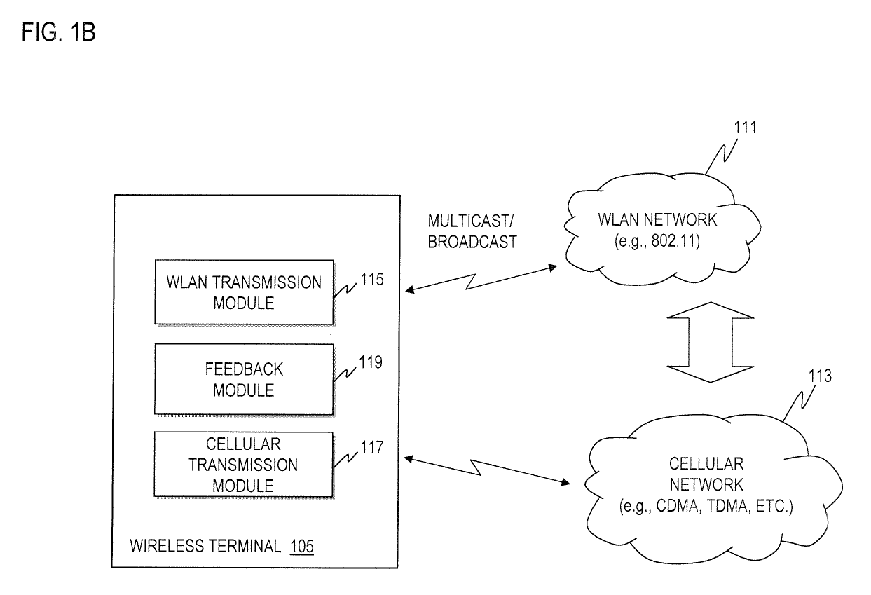

FIGS. 1A and 1B are diagrams, respectively, of a wireless access point and a wireless terminal capable of providing multicast active-station power-save optimization, in accordance with various embodiments of the invention. In FIG. 1A, an exemplary Access Point (AP) 101 includes a power save module 103 to permit selective bypassing of a power-save scheme of one or more wireless stations 105 (or user terminals (UTs)), which can be referred to Basic Service Set (BSS) 201 in an IEEE 802.11 system). The access point 101 also includes a processor 107 that is configured to execute instructions relating to selectively bypassing the power save process to increase performance (e.g., throughput). That is, data stored within a transmission buffer (e.g., packet buffer) 109 can be transmitted with a relatively high throughput. As seen, the access point 101 permits communication over a wireless network 111, which can be a local area network (LAN). For the purposes of illustration, the wireless LAN 111 is compliant with IEEE 802.11.

In accordance with 802.11 terminology, the AP 101 and the terminals 105 can be referred to as stations or STAs. The wireless terminal 105 can be any communication device, including phones, Personal Digital Assistants (PDAs), and computers of various types (laptops, personal computers, workstations, terminals of any type).

FIG. 1B is a diagram of a multicast enabled wireless terminal 105 capable of operating in the system of FIG. 1A, according to an embodiment of the present invention. It is contemplated that the wireless terminal 105, in an exemplary embodiment, can operate directly with different radio networks: WLAN 111 or a cellular network 113. By way of example, the cellular network 113 can employ various technologies to provide communications between the terminal 105 and the network 113, such as spread spectrum (such as Code Division Multiple Access (CDMA) networks), or Time Division Multiple Access (TDMA).

To support the dual mode configuration, the wireless terminal 105 includes a WLAN transmission module 115 for interfacing with the WLAN 111 and a cellular transmission module 117 for communicating over the cellular network 113. Additionally, the wireless terminal 105 includes a feedback module 119 through which the terminal 105 can signal—e.g., send a message DTIM (Delivery Traffic Indication Message) to indicate that the terminal 105 belongs to a multicast group that is in active mode.

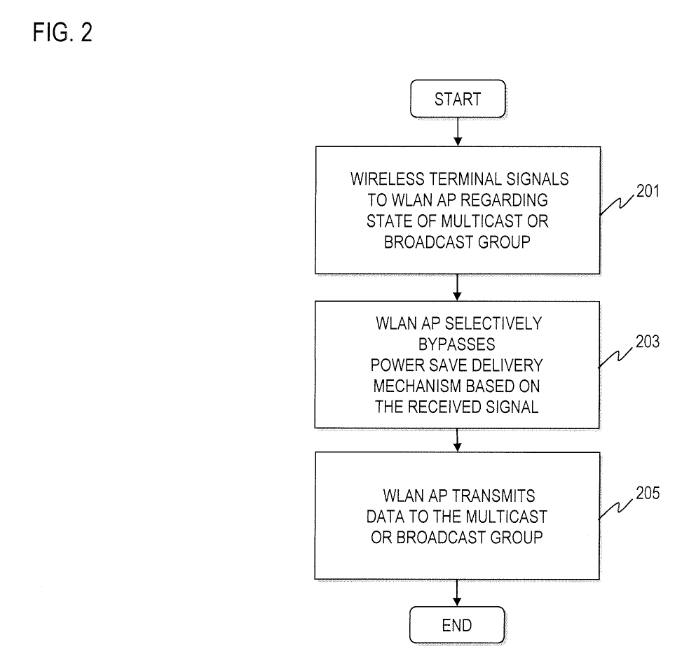

As mentioned the terminal 105 can operate within a network for broadcast multicast service that is compliant with IEEE 802.11, which is explained with respect to FIG. 2.

FIG. 2 is a flowchart of a process for managing power saving mechanisms, in accordance with various embodiments of the invention. This process is explained with respect to the system of FIGS. 1A and 1B. Under this scenario, in step 201, the wireless terminal 105 (within a certain multicast group) signals to the AP 101 to provide information about the state of the multicast group—e.g., the terminals 105a and 105b within the group are active. In response to this message, in step 203, the AP 101 can bypass the power-save delivery mechanism, thereby permitting transmission of the multicast or broadcast data (instead of buffering such data), per step 205.

Thus, the above approach, in exemplary embodiments, reduce buffering requirements in the WLAN AP 101. This scheme also provides load-balancing of multicast traffic as traffic burst after DTIM are reduced; this is particularly beneficial if high-rate traffic is required. Furthermore, energy savings can be obtained in terminals 105 that are not a part of the multicast group, as packets bursts after multicast are reduced (namely stations in legacy-mode need to listen all the broadcast/multicast frames).

By way of example, the above arrangement is compliant with IEEE Std. 802.11, entitled “Wireless LAN Medium Access Control (MAC) and Physical Layer (PHY) specifications,” 1999 Ed. (Rev. 2003) (which is incorporated herein by reference in its entirety).

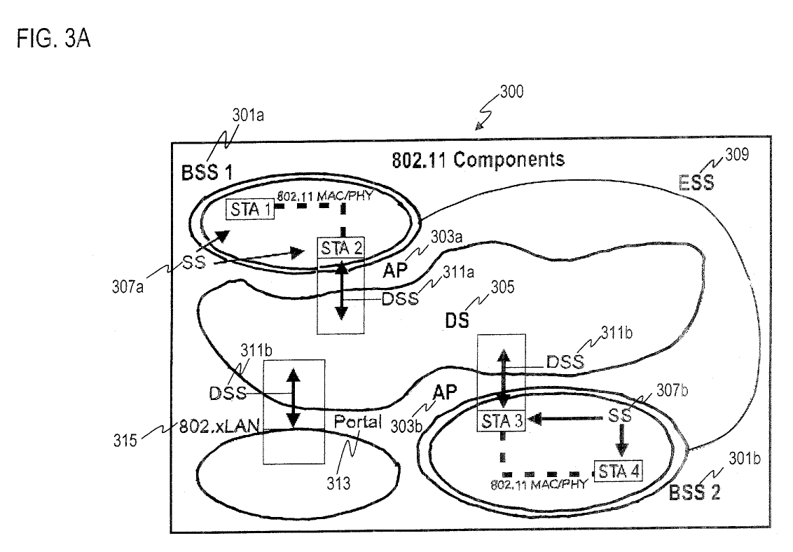

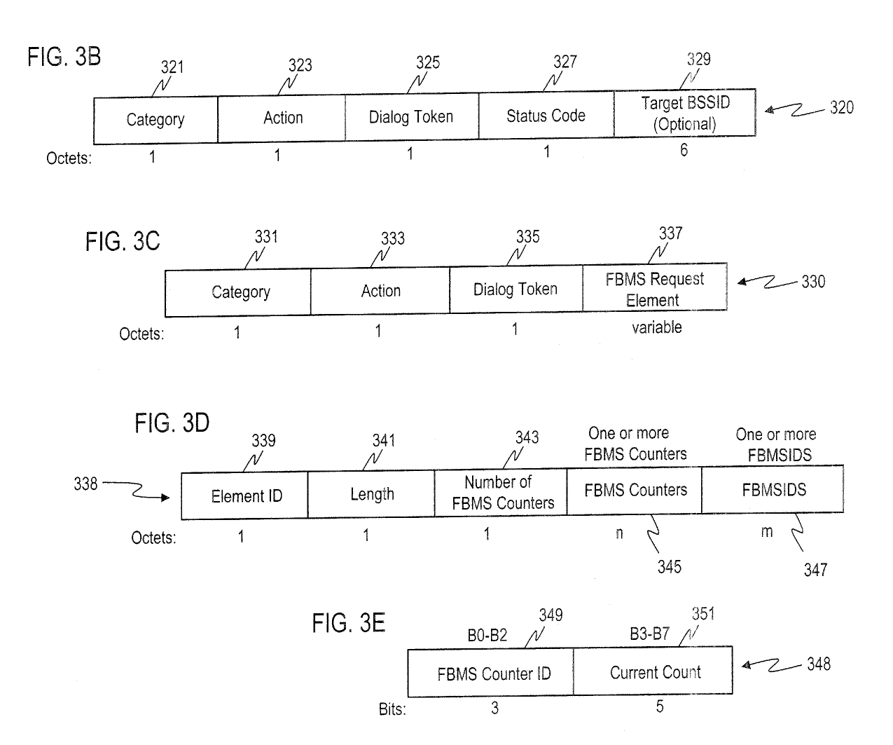

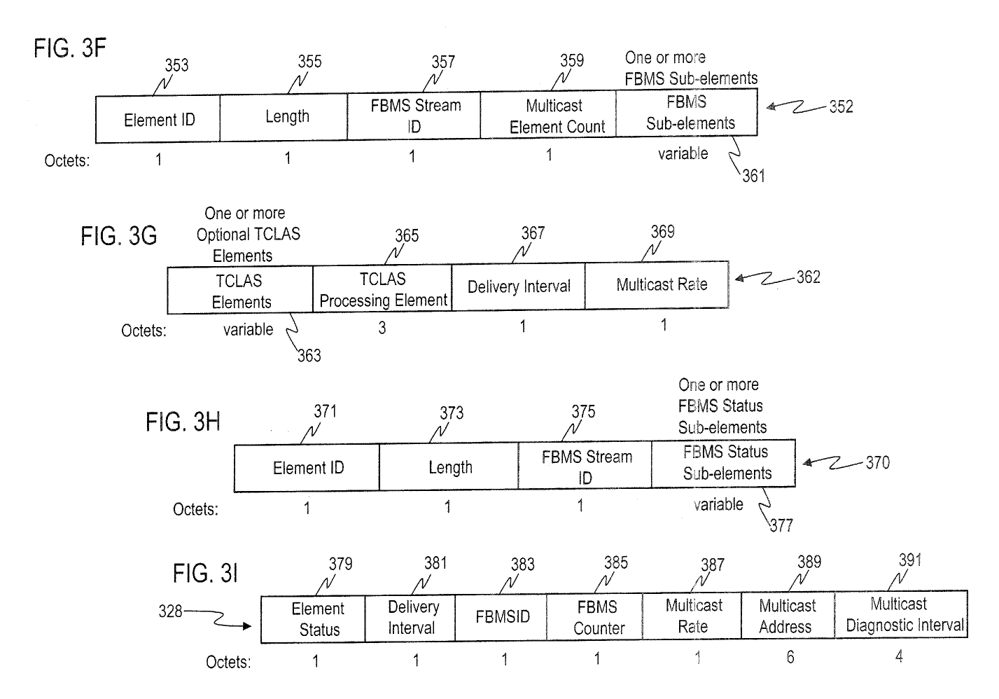

FIG. 3A is a diagram of an exemplary architecture of IEEE 802.11 components capable of providing multicast/broadcast services, in accordance with an embodiment of the invention. According to an exemplary embodiment, the system 300 includes several components that interact to provide a wireless local area network (LAN) for supporting station mobility. The basic service set (BSS) 301 is the basic building block of an IEEE 802.11 LAN 315. In this exemplary scenario, two BSSs 301 are shown; each of which has two stations 307 that are members of the BSS 301. Each BSS 301 is depicted as the coverage area within which the member stations 307 of the BSS 301 may remain in communication. It is noted that if a station 307 moves out of its BSS 301, it can no longer directly communicate with other members of the BSS 301.

In an exemplary embodiment, a mode of operation is possible when IEEE 802.11 stations 307 are able to communicate directly. Because this type of IEEE 802.11, LAN 315 is often formed without pre-planning (for only as long as the LAN 315 is needed), this type is often referred to as an ad hoc network. Instead of existing independently, a BSS 301 may also form a component of an extended form of network that is built with multiple BSSs 301. The architectural component used to interconnect BSSs 301 is the distribution system (DS) 305. An access point (AP) 303 is a STA (station) 311 that provides access to the DS 305 by providing DS services in addition to acting as a STA 307. In this scenario, data moves transported between a BSS 301 and the DS 305 via an AP 303.

In an exemplary embodiment, the association between a STA 307 and a BSS 301 is dynamic, —e.g., STAs 307 are turn on, turn off, come within range, and go out of range. To become a member of an infrastructure BSS 301, an association is first established. These associations are dynamic and involve the use of the DSS (Distribution System Service) 311. The DSS 311 includes a set of services provided by the distribution system (DS) 305 that enable a medium access control (MAC) layer (not shown) to transport MAC service data units (MSDUs) (not shown) between stations 307 that are not in direct communication with each other over a single instance of the wireless medium (WM). These services include transport of MSDUs between the access points (APs) 307 of basic service sets (BSSs) 301 within an extended service set (ESS) 309, transport of MSDUs between portals and BSSs 301 within an ESS 309, and transport of MSDUs between stations in the same BSS 301 in cases where the MSDU has a multicast or broadcast destination address or where the destination is an individual address. However, the station sending the MSDU can elect to involve the DSS 311, which are provided between pairs of IEEE 802.11 MACs.

According to an embodiment, the DS 305 and BSSs 301 create a wireless network of arbitrary size and complexity. IEEE 802.11 refers to this type of network as the extended service set (ESS) 309 network. Stations within an ESS 309 may communicate; and mobile stations may move from one BSS 301 to another within the same ESS 309.

In an exemplary embodiment, a portal (i.e., a logical architecture component) is introduced to integrate the IEEE 802.11 architecture with a traditional wired LAN 315. The portal 313 is a logical point at which MSDUs from an integrated non-IEEE 802.11 LAN enter the IEEE 802.11 DS 305. For example, the portal 313 as shown in the FIG. 3A is configured to connect to a wired IEEE 802 LAN 315. All data from non-IEEE 802.11 LANs enter the IEEE 802.11 architecture via the portal 313. The portal 313 provides logical integration between the IEEE 802.11 architecture and existing wired LANs. It is possible for one device to offer both the functions of an AP 303 and a portal 313; this could be the case when a DS 305 is implemented from IEEE 802 LAN components. In IEEE 802.11, the ESS architecture (APs 303 and DS 305) provides traffic segmentation and range extension. Logical connections between an IEEE 802.11 LAN 315 and other LANs are via the portal 313. Portals 317 connect between the DSM and the LAN medium that is to be integrated.

The IEEE 802.11 choice of address space implies that for many instantiations of the IEEE 802.11 architecture, the wired LAN MAC address space and the IEEE 802.11 MAC address space may be the same. In those situations where a DS 305 that uses MAC level IEEE 802 addressing, all three of the logical address spaces used within a system could be identical. While this is a common case, it is not the only combination allowed by the architecture. The IEEE 802.11 architecture allows for all three logical address spaces to be distinct. A multiple address space example is one in which the DS 305 implementation uses network layer addressing. In a multicast/broadcast example, a medium access control (MAC) address has the group bit set. A multicast MAC service data unit (MSDU) is one with a multicast destination address. A multicast MAC protocol data unit (MPDU) or control frame is one with a multicast receiver address.

This service provides peer LLC (Logical Link Control) entities with the ability to exchange MAC Service Data Units (MSDUs). To support this service, the local MAC uses the underlying PHY-level services to transport an MSDU to s peer MAC entity, where it will be delivered to the peer LLC. Such asynchronous MSDU transport is performed on a best-effort connectionless basis. There are no guarantees that the submitted MSDU will be delivered successfully. Broadcast/multicast transport is part of the asynchronous data service provided by the MAC.

Under the multicast/broadcast WLAN architecture of FIG. 3, a mobile station (STA) 311 can operate in two modes: active mode or PS (Power Save) mode. In the active mode, the station 307 is fully powered; accordingly, the station 307 can send and receive packets at any time. In the PS mode, a station 307 can be in one of two states: a “sleep” state and an “awake” state. Generally, in power-saving mode, the station 307 remains in the sleep mode; the station 307 periodically wakes up to check whether there are buffered frames in AP 303. When a station 307 is in the power saving mode, the AP (Access Point) 303 buffers all the frames that are directed to that station 307.

Embedded in the beacon frames that the AP 303 sends out is a delivery traffic indication message (DTIM). TIM contains information about pending frames. By reading the TIM, a station in power saving mode can determine if there are data frames stored for it and decide if it wants to change to the awake state to receive the pending frames from the AP 303. TIM indicates whether any frames directed to the station are pending in the AP 303.

To enter the power saving mode, the station 307 informs the AP 303. A signal with a power saving request is sent from the station 307 to the AP 303 following the basic medium access procedure. A reply is sent by the AP 303 and received by the station 307 before the station 307 can enter the power saving mode. Once the exchange is successful, the station 307 can operate with little power consumption, and the AP 101 buffers all the frames addressed to this station 307. However, this causes delay in the delivery of multicast/broadcast packets to be after the DTIM frame. In other words, this basically can limit the frame delivery rate up to DTIM periods as well as burdens the WLAN AP 303 buffer to hold this traffic. This traditional power saving mode scheme can cause unnecessary energy consumption due to the problems of an overhearing, a back-off time delay and possible packet collisions.

By contrast, the approach of the invention, according to certain embodiments, minimizes energy consumption and maximizes data throughput in medium access control (MAC), particularly within a multicast/broadcast network.

According to one embodiment, it is assumed that all the stations 307 in WLAN AP 303 are supporting the multicast group signaling and all stations belonging to the same multicast group that are in active mode, then the multicast-delivery in power-save mode for that specific group can be turned off (i.e., bypassed) and frames delivered in active-mode. Otherwise, the normal 802.11 multicast power-save scheme as mentioned above can be executed for that specific group.

As for the multicast rate, the AP 303 indicates its ability to provide multicast services at higher data rates by its advertisement of the FMBS (Flexible Broadcast Multicast Service) capability. In addition, the FBMS capabilities enables a non-AP STA (not shown) to request delivery of broadcast or multicast frames at multiples of the DTIM (Delivery Traffic Indication Message) interval, allowing the non-AP STA to remain in power save state for longer periods of time. FBMS also supports Maximum Multicast Rate Processing, enabling the AP 303 to indicate its ability to provide multicast services at higher data rates, and the non-AP STA to request use of a higher rate. This enables multicast frames to be sent at higher data rates, reducing the amount of basic rate traffic over radio link. The STA 307 includes the FBMS Request information element in the (re) association Request and FBMS request frames (to indicate a request to use the FBMS service, including use of a higher multicast rate. The AP 303 selects the multicast rate to use with the STA 307 and indicates the rate and multicast address in the FBMS Response information element in the (Re) association Response frame and FBMS Response frame.

The STA 307 may request membership in a multicast group or change in multicast data rate or delivery interval using the FBMS Request action frame. The AP 303 responds to an FBMS Request action frame with an FBMS Response action frame, indicating the FBMS information element, including the multicast address. The AP 303 may send an FBMS Response action frame to the STA 307 to change the STA's multicast rate, or Delivery interval. When the AP 303 sends an FBMS Response frame to the STA 307 with an Element Status field value of 8, indicating “Override due to AP multicast rate policy,” the STA 307 shall not further FBMS Request frames to request a change in the multicast rate. More than one FBMSID (Flexible Broadcast Multicast Service Identifier) may have the same delivery interval. The multicast Diagnostic Interval, included in the FBMS Status sub-element in the FBMS Response frame specifies the maximum number of beacon intervals for which the STA 307 may keep multicast service traffic counts. If multicast Diagnostic Reports are generated by the STA 307, the STA 307 shall send at least one Multicast Diagnostic Report with a Multicast Reporting Reason of Performance measurement within each Multicast Diagnostic Interval.

The format of a BSS Transition Management Response frame body 320 is shown in FIG. 3B. The BSS Transition Management Response frame 320 uses the Action frame body format and is optionally transmitted by a STA 307 in response to a BSS Transition Management Request frame (not shown). The category field 321 is set to the value indicating the Wireless Network Management category, as specified in Table 1.

TABLE 1

| Code | Meaning |
|---|---|
| <ANA*> | Wireless Network Management |
| (<ANA*> + 1) − 126 | Reserved |

As used herein, “<ANA>” designates a configurable value. The Action field 323 is set to the value indicating BSS Transition Response, as specified in Table 2.

TABLE 2
Wireless Network Management Action Field Values

| Action Filed Value | Description |
|---|---|
| 0 | Event Request |
| 1 | Event Report |
| 2 | Diagnostic Request |
| 3 | Diagnostic Report |
| 4 | Presence Request |
| 5 | Presence Response |
| 6 | Presence Configuration Request |
| 7 | Presence Configuration Response |
| 8 | BSS Transition Management Query |
| 9 | BSS Transition Management Request |
| 10 | BSS Transition Management |
| | Response |
| 11 | FBMS Request |
| 12 | FBMS Response |
| 13 | Co-located Interference Request |
| 14 | Co-located Interference Response |
| 15 | TFS Request |
| 16 | TFS Response |
| 17 | TFS Notify |
| 18 | Sleep Mode Request |
| 19 | Sleep Mode Response |
| 20 | TIM Broadcast Request |
| 21 | TIM Broadcast Response |
| 22 | TIM |
| 23-255 | Reserved |

The Dialog Token field 325 is set to the value in the corresponding BSS Transition Management Request frame. The BSS Transition Management Response frame is only transmitted in response to BSS Transition Management Request frame. The Status code field 327 contains the status code in response to a BSS Transition Management Request as defined in Table 3.

TABLE 3

| Status Code | Status Code Description |
|---|---|
| 0 | Accept |
| 1 | Reject-Unspecified reject reason |
| 2 | Reject-Insufficient Beacon frames received |
| | from all candidates |
| 3 | Reject-Insufficient available capacity from |
| | All candidates |
| 4-255 | Reserved |

If STA 307 decides to roam to another BSS, then the status code is set to 0. If STA 307 wants to stay with the current BSS 301, the status code indicates a reject reason. The Target Basic Service Set Identifier (BSSID) field 329 is the BSSID of the BSS 301 that STA transitions to. The field is not present if the STA 307 does not transition or if no transition information is available.

A FBMS Request frame 330 (FIG. 3C) is sent by a non-AP STA to the AP 303 to request the specified FBMS and to response delivery intervals for a set of broadcast/multicast streams. The FBMS Request frame 330 is also sent by a non-AP STA to request a modification to a previous FBMS Request. The Category field 331 is set to the value indicating the Wireless Network Management category, as specified in the Table 1.

The Action field 333 is set to the value indicating FBMS Request frame, as specified in the Table 2. The dialog Token field 335 is nonzero value which identifies the FBMS Request/Response transaction. The dialog token 335 is unique for each FBMS Request frame sent to a given destination MAC address. The FBMS Request Element field 337 indicates the broadcast/multicast traffic streams that are requested by the non-AP STA. The FBMS Request Element field 337 contains a FBMS Request element. The FBMS Request element defines information about the Broadcast/Multicast frames being requested by the non-AP STA. The format of FBMS Request element is shown in FIG. 3D.

The FBMS Descriptor element defines information about Broadcast/Multicast frames buffered in an AP 303. It may be present in the Beacon frames if the variable, dot11WirelessManagementImplemented (which indicates whether the wireless management feature is active), is true and if the AP 303 supports FBMS. If there is no active FBMS stream then the FBMS Descriptor element is not included in the Beacon frame. The format of the FBMS Descriptor element 338 is shown in FIG. 3D. The Element ID field 339 is equal to the FBMS Descriptor value in Table 4.

TABLE 4

| Information Element | Element ID | Length (in octets) |
|---|---|---|
| Event Request (see Appendix) | <ANA> | 4 to 256 |
| Event Report (see Appendix) | <ANA> + 1 | 5 to 256 |
| Diagnostic Request (see Appendix) | <ANA> + 2 | 4 to 256 |
| Diagnostic Report (see Appendix) | <ANA> + 3 | 5 to 256 |
| Presence Parameters (see Appendix) | <ANA> + 4 | 2 to 256 |
| Multiple BSSID (see Appendix) | <ANA> + 5 | 3 to 256 |
| Multiple SSID (see Appendix) | <ANA> + 6 | 2 to 256 |
| Multiple BSSID-Index (see | <ANA> + 7 | 3 to 5 |
| Appendix) | | |
| FBMS Descriptor (see Appendix) | <ANA> + 8 | 3 to 256 |
| FBMS Request (see Appendix) | <ANA> + 9 | 4 to 256 |
| FBMS Response (see Appendix) | <ANA> + 10 | 3 to 128 |
| Traffic Generation (see Appendix) | <ANA> + 11 | 3 |
| AC Station Count (see Appendix) | <ANA> + 12 | 3 to 11 |
| BSS Max Idle Period (see | <ANA> + 13 | 3 |
| Appendix) | | |
| TFS Request (see Appendix) | <ANA> + 14 | 5 to 256 |
| TFS Response (see Appendix) | <ANA> + 15 | 2 to 256 |
| Sleep Mode (see Appendix) | <ANA> + 16 | 5 |
| TIM Broadcast Request (see | <ANA> + 17 | 3 |
| Appendix) | | |
| TIM Broadcast Response (see | <ANA> + 18 | 8 |
| Appendix) | | |
| Reserved | <ANA> + 19, | |
| | 220 | |

The Length field 341 is set to 1+n+m, where n is the number of FBMS Counters 343 present and m indicates the number of 1-octet FBMSIDs present in the information element.

The FBMS Counters field 345 contains one or more FBMS Counters. The format of the FBMS Counter is shown in FIG. 3D. When there are one or more active FBMS streams 347, then at least one FBMS counter must be present in the FBMS Descriptor element. Optionally, from 2 to a maximum of eight counters are permitted. The FBMS counters are used by non-AP STA to identify the DTIM beacon after which broadcast/multicast frames assigned to a particular delivery interval are transmitted.

FIG. 3E shows the FBMS counter definition format 348. The FBMS Counter ID field 349 includes three least significant bits of the FBMS Counter ID assigned in the FBMS Response element. The Current Count field 351 indicates how many DTIM Beacon (including the current one) frames appear before the next DTIM Beacon frame after which the broadcast/multicast frames assigned to a particular delivery interval are scheduled to be transmitted. The FBMSIDs field contains one or more FBMSIDs. The FBMSID is a 1-octet identifier. Inclusion of an FBMSID indicates the AP 303 has buffered frames for the corresponding broadcast/multicast stream which is scheduled for transmission immediately after the DTIM Beacon frame. The FBMS Descriptor element is included in Beacon frame, as described in Table 5.

TABLE 5

| Order | Information | Notes |
|---|---|---|
| | Extended | The Extended Capabilities element shall be |
| | Capabilities | present if the |
| | | dot112040BSSCoexistenceManagementSupport |
| | | attribute is true or if |
| | | dot11WirelessManagementImplemented is true, |
| | | and may be present otherwise. |
| | Presence | The Presence Parameters element is present if |
| | Parameters | dot11WirelessManagementImplemented is true |
| | | and the Presence bit in the Extended Capabilities |
| | | element is set to 1. |
| | Multiple | The Multiple BSSID element may be present if |
| | BSSID | dot11WirelessManagementImplemented is true. |
| | FBMS | The FBMS Descriptor element is present if |
| | Descriptor | dot11WirelessManagementImplemented is true. |

An AP 303 uses the FBMS Descriptor element in Beacon frames to indicate to which broadcast or multicast addresses the buffered broadcast/multicast frames are targeted. This element is present only if the bit for AID 0 is set to 1. The FBMS Descriptor element for a non-transmitted BSSID is included in the Multiple BSSID element sent in a Beacon frame. The FBMS Descriptor element is present in the Multiple BSSID element only if the TIM field indicates there are buffered multicast frames for the non-transmitted BSSID.

The FBMS Request element defines information about the Broadcast/Multicast frames being requested by the non-AP STA. The format of FBMS Request element is shown in FIG. 3F. The Element ID field 353 is set to the FBMS Request value in Table 4. The Length field 355 is set to 2+n, where n indicates the total length of all FBMS Sub-elements contained in the element. The FBMS Stream ID filed 357 contains a unique identifier for a FBMS stream, assigned by the AP 303 upon original subscription. If this is a new request then the FBMS Stream ID value 357 is set to 0. Otherwise, the FBMS Stream ID value 357 is set to the value assigned in the FBMS Response element. The FBMS Stream ID 357 is fixed during the lifetime of the FBMS Stream.

The Multicast Element Count 359 indicates the number of the FBMS Sub-elements present 361. The format 362 of the FBMS sub-element 361 is shown in FIG. 3F. The TCLAS Elements field 363 contains one or more Traffic Classifier (TCLAS) information elements to classify the Broadcast/Multicast stream as defined in Table 6.

TABLE 6

| Classifier type | Classifier parameters |
|---|---|
| 3 | Filter Offset parameters |
| 4-255 | Reserved |

For Classifier Type 3, the classifier parameters are defined by a filter offset field and a filter value field. The Frame Classifier field of Classifier Type 3 for Filter Offset parameters is defined as follows: Classifier Type (3) field (e.g., 1 octet in length); Classifier Mask field (e.g., 1 octet in length); Filter Offset field (e.g., 1 octet in length); and Filter Value field (e.g., variable length). The value of the Filter Offset field is the number of octets following the MAC header at which the Filter Value is compared, after any necessary decryption or disaggregation. A value of zero for the Filter Offset indicates that the Filter Value is to be compared to the octet immediately following the MAC header. The Filter Value is an octet string that is compared to the frame content, beginning at the octet indicated by the Filter Offset.

The TCLAS Processing Element field 365 is optionally present and defines how multiple TCLAS information elements are processed. The TCLAS Processing element is present in the ADDTS Request, and ADDTS Response and FBMS Request frames if there are multiple TCLASs associated with the request.

The Delivery Interval field 367 defines the number of DTIMs that the stream is transmitted at. The default value is 1. The value set to 0 indicates that requesting Non-AP STA does not use the FBMS sub-element anymore. The Multicast Rate field 369 specifies the highest data rate, in 0.5 Mb/s units, at which the STA can reliably receive multicast frames. If no value is provided by the STA 307, this field is set to 0. The FBMS Request element is included in FBMS Request frames. The FBMS Request frame is sent by a non-AP STA to the AP to request the specified FBMS and to propose delivery intervals for a set of broadcast/multicast streams. The FBMS Request frame is also sent by a non-AP STA to request a modification to a previous FBMS Request. The format of the frame is shown in FIG. 3C.

Association Request frames are described in Table 7:

TABLE 7

| Order | Information | Notes |
|---|---|---|
| | Extended | The Extended Capabilities element shall be present |
| | Capabilities | if the |
| | | dot112040BSSCoexistenceManagementSupport |
| | | attribute is true or if |
| | | dot11WirelessManagementImplemented is true, |
| | | and may be present otherwise. |
| | FBMS | The FBMS Request element may be present if |
| | Request | dot11WirelessManagementImplemented is true and |
| | | the FBMS bit in the Extended Capabilities element |
| | | is set to 1. |
| | Presence | The Presence Parameters element is present if |
| | Parameters | dot11WirelessManagementImplemented is true and |
| | | the Presence bit in the Extended Capabilities |
| | | element is set to 1. |
| | Traffic | The Traffic Generation element is present if |
| | Generation | dot11WirelessManagementImplemented is true. |
| | TIM | The TIM Broadcast Request element may be |
| | Broadcast | present if |
| | Request | dot11WirelessManagementImplemented is true |
| | | and the TIM Broadcast bit in the Extended |
| | | Capabilities element is set to 1. |

Reassociation Request frames are described in Table 8:

TABLE 8

| Order | Information | Notes |
|---|---|---|
| | Extended | The Extended Capabilities element shall be present |
| | Capabilities | if the |
| | | dot112040BSSCoexistenceManagementSupport |
| | | attribute is true or if |
| | | dot11WirelessManagementImplemented is true, |
| | | and may be present otherwise. |
| | FBMS | The FBMS Request element may be present if |
| | Request | dot11WirelessManagementImplemented is true |
| | | and the FBMS bit in |
| | | the Extended Capabilities element is set to 1. |
| | Presence | The Presence Parameters element is present if |
| | Parameters | dot11WirelessManagementImplemented is true |
| | | and the Presence bit in the Extended Capabilities |
| | | element is set to 1. |
| | Traffic | The Traffic Generation element is present if |
| | Generation | dot11WirelessManagementImplemented is true. |
| | TFS Request | The TFS Request element is present if |
| | | dot11WirelessManagementImplemented is true |
| | | and the TFS bit in the Extended Capabilities |
| | | element is set to 1. |
| | Sleep Mode | The Sleep Mode element is present if |
| | | dot11WirelessManagementImplemented is true |
| | | and the Sleep Mode bit in Extended Capabilities |
| | | element is set to 1. |
| | TIM | The TIM Broadcast Request element may be |
| | Broadcast | present if |
| | Request | dot11WirelessManagementImplemented is true |
| | | and the TIM Broadcast bit in the Extended |
| | | Capabilities element is set to 1. |

The use of the FBMS Request element and frames is more fully described as follows. A non-AP STA requests use of FBMS by sending an FBMS Request frame or (Re)association Request frame includes requested FBMS elements. The STA 307 identifies all streams to the AP 303 using FBMS elements. This is a declaration of all streams in which the STA 307 is interested. For each stream, the STA 307 proposes a delivery interval for the requested FBMS element. The AP 303 can adopt the proposed delivery interval or provide an alternate delivery interval for the stream. A status value of Accept is transmitted by the AP 303 when the requested delivery interval is supported by the AP 303. A status value of Deny is transmitted by the AP 303 when the AP 303 denies the STA's requested delivery interval and TCLAS completely. A status value of Override is transmitted by the AP 303 when the AP 303 denies the requested delivery interval but can support an alternate delivery interval for the requested TCLAS. The STA 307 shall comply with the AP's override value. If the STA 307 does not accept this overridden rate, then the STA 307 shall send a new request with the TCLAS Element removed.

A non-AP STA may indicate that it is no longer using an FBMS Element by transmitting an FBMS Request frame without that FBMS Element contained in it or transmitting a FBMS Request frame including that FBMS Element for which the delivery interval is set to 0. The AP 303 shall send an FBMS response frame with the FBMS Element status field value set to “1” (Accept) upon receipt of the FBMS Request frame.

If an AP 303 receives an FBMS Request for an FBMS stream which has already been assigned to a particular delivery interval (and FBMS Counter ID), the AP 303 may adjust the corresponding FBMS Counter Current Count bit-field in the FBMS Descriptor element to align the transmission time of the FBMS stream to the transmission time of other FBMS streams that the STA 307 is already receiving. The AP accomplishes this by changing the Current Count bit-field value. The Current Count value shall be changed only by holding the value of the field same in two consecutive Beacon frames in which the Current Count bit-field appears. The algorithm by which the AP 303 chooses to align or offset the different FBMS counters is unspecified.

The AP 303 may update the Delivery Interval field for an FBMSID by sending an unsolicited FBMS Response frame to the appropriate address with updated Delivery Interval field when the Current Count bit-field value reaches zero. The AP 303 may terminate a particular FBMS Element by sending an unsolicited FBMS Response frame to the appropriate address with Delivery Interval set to 0 and the Element Status set to “terminate”. The AP 303 may send an unsolicited FBMS Response frame when the AP 303 changes the delivery interval for an FBMSID. The FBMS Response frame is transmitted as a unicast frame to all non-STAs that are using that FBMSID. For any sleeping non-AP STAs, normal power-save transmission rules shall apply where the TIM bit is set for each sleeping non-AP STA and the non-AP STA shall retrieve the queued frames during the next PS-POLL exchange.

The FBMS Response element defines information about the broadcast/multicast status. The format 370 of the FBMS Response element is shown in FIG. 3H. The Element ID field 371 is set to the FBMS Response value in Table 4. The Length field 373 is set to 1+n, where n indicates the total length of all FBMS Sub-elements contained in the element. The FBMS Stream ID 375 field is assigned by the AP for a particular FBMS stream, and provides a unique identifier for this stream within the BSS. The FBMS Status Sub-elements 377 field contains one or more FBMS Status sub-elements.

The format 378 of the FBMS Status sub-element is shown in FIG. 3I. The Element Status field 379 indicates the status of the AP responding to the STA's requested delivery interval 381, as indicated in Table 9.

TABLE 9

| Value | Description |
|---|---|
| 0 | Accept |
| 1 | Deny, due to malformed request or ambiguous classifier |
| 2 | Deny, due to lack of resources on AP |
| 3 | Deny, due to requested classifier(s) matching 2 or |
| | More existing streams on different intervals |
| 4 | Deny, by policy, requested stream is not permitted to |
| | Participate in FBMS |
| 5 | Override, due to existing stream with different delivery |
| | interval |
| 6 | Override, due to policy limits on AP |
| 7 | Override, due to AP changed the delivery interval |
| 8 | Override, due to AP multicast rate policy |
| 9 | Terminate, due to AP policy change |
| 10 | Terminate, due to lack of resources of AP |
| 11 | Terminate, due to other FBMS stream with higher |
| | priority |
| 12-255 | Reserved |

The Delivery Interval field 381 defines the number of DTIMs at which the stream is transmitted. The value set to 0 indicates that requesting Non-AP STA does not use this FBMS sub-element anymore. The FBMSID field 383 is assigned by the AP and provides a unique identifier for this stream within the BSS 301. The format of the FBMS Counter field 385 is shown in FIG. 3I. The Multicast Rate field 387 specifies the data rate in 0.5 Mb/s units to be used for the multicast service. If the value of the Multicast Rate field 387 is set to 0 then the data rate is undefined. The Multicast Address field 389 specifies the multicast MAC address for the multicast service. The Multicast Diagnostic Interval field 391 specifies the maximum number of beacon interval for which the STA 307 keeps multicast service traffic counts.

The Multicast Diagnostic Interval, included in the FBMS Status sub-element in the FBMS Response frame specifies the maximum number of beacon intervals for which the STA 307 may keep multicast service traffic counts. If Multicast Diagnostic Reports are generated by the STA 307, the STA 307 shall send at least one Multicast Diagnostic Report with a Multicast Reporting Reason of Performance measurement within each Multicast Diagnostic Interval. Use of the data fields provided in the Multicast Diagnostic Report by the AP 303 is unspecified.

The FBMS Response element is included in FBMS Response frames, Association Response frames, and Reassociation Response frames.

It is noted that the described frame formats are exemplary in nature, and can be tailored to the particular system and application.

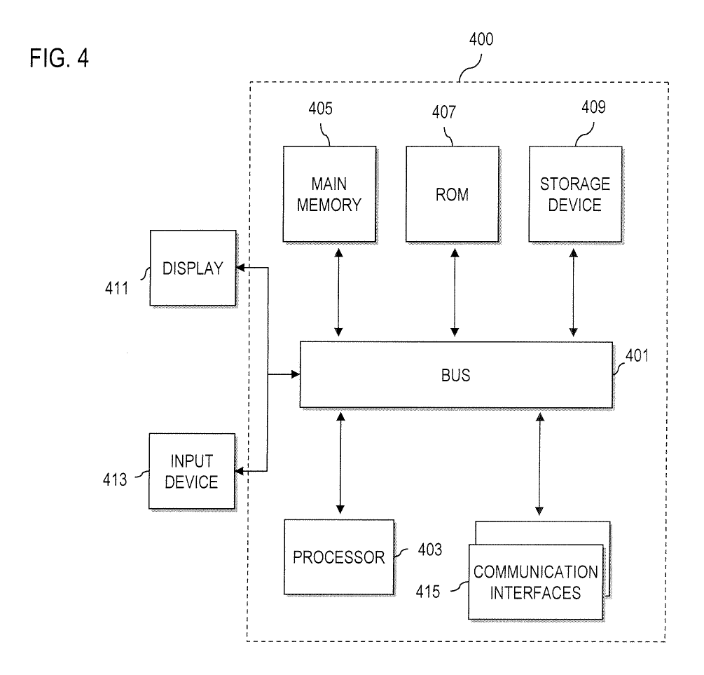

One of ordinary skill in the art would recognize that the processes for managing power saving mechanisms may be implemented via software, hardware (e.g., general processor, Digital Signal Processing (DSP) chip, an Application Specific Integrated Circuit (ASIC), Field Programmable Gate Arrays (FPGAs), etc.), firmware, or a combination thereof. Such exemplary hardware for performing the described functions is detailed below with respect to FIG. 4.

FIG. 4 illustrates exemplary hardware upon which various embodiments of the invention can be implemented. A computing system 400 includes a bus 401 or other communication mechanism for communicating information and a processor 403 coupled to the bus 401 for processing information. The computing system 400 also includes main memory 405, such as a random access memory (RAM) or other dynamic storage device, coupled to the bus 401 for storing information and instructions to be executed by the processor 403. Main memory 405 can also be used for storing temporary variables or other intermediate information during execution of instructions by the processor 403. The computing system 400 may further include a read only memory (ROM) 407 or other static storage device coupled to the bus 401 for storing static information and instructions for the processor 403. A storage device 409, such as a magnetic disk or optical disk, is coupled to the bus 401 for persistently storing information and instructions.

The computing system 400 may be coupled via the bus 401 to a display 411, such as a liquid crystal display, or active matrix display, for displaying information to a user. An input device 413, such as a keyboard including alphanumeric and other keys, may be coupled to the bus 401 for communicating information and command selections to the processor 403. The input device 413 can include a cursor control, such as a mouse, a trackball, or cursor direction keys, for communicating direction information and command selections to the processor 403 and for controlling cursor movement on the display 411.

According to various embodiments of the invention, the processes described herein can be provided by the computing system 400 in response to the processor 403 executing an arrangement of instructions contained in main memory 405. Such instructions can be read into main memory 405 from another computer-readable medium, such as the storage device 409. Execution of the arrangement of instructions contained in main memory 405 causes the processor 403 to perform the process steps described herein. One or more processors in a multi-processing arrangement may also be employed to execute the instructions contained in main memory 405. In alternative embodiments, hard-wired circuitry may be used in place of or in combination with software instructions to implement the embodiment of the invention. In another example, reconfigurable hardware such as Field Programmable Gate Arrays (FPGAs) can be used, in which the functionality and connection topology of its logic gates are customizable at run-time, typically by programming memory look up tables. Thus, embodiments of the invention are not limited to any specific combination of hardware circuitry and software.

The computing system 400 also includes at least one communication interface 415 coupled to bus 401. The communication interface 415 provides a two-way data communication coupling to a network link (not shown). The communication interface 415 sends and receives electrical, electromagnetic, or optical signals that carry digital data streams representing various types of information. Further, the communication interface 415 can include peripheral interface devices, such as a Universal Serial Bus (USB) interface, a PCMCIA (Personal Computer Memory Card International Association) interface, etc.

The processor 403 may execute the transmitted code while being received and/or store the code in the storage device 409, or other non-volatile storage for later execution. In this manner, the computing system 400 may obtain application code in the form of a carrier wave.

The term “computer-readable medium” as used herein refers to any medium that participates in providing instructions to the processor 403 for execution. Such a medium may take many forms, including but not limited to non-volatile media, volatile media, and transmission media. Non-volatile media include, for example, optical or magnetic disks, such as the storage device 409. Volatile media include dynamic memory, such as main memory 405. Transmission media include coaxial cables, copper wire and fiber optics, including the wires that comprise the bus 401. Transmission media can also take the form of acoustic, optical, or electromagnetic waves, such as those generated during radio frequency (RF) and infrared (IR) data communications. Common forms of computer-readable media include, for example, a floppy disk, a flexible disk, hard disk, magnetic tape, any other magnetic medium, a CD-ROM, CDRW, DVD, any other optical medium, punch cards, paper tape, optical mark sheets, any other physical medium with patterns of holes or other optically recognizable indicia, a RAM, a PROM, and EPROM, a FLASH-EPROM, any other memory chip or cartridge, a carrier wave, or any other medium from which a computer can read.

Various forms of computer-readable media may be involved in providing instructions to a processor for execution. For example, the instructions for carrying out at least part of the invention may initially be borne on a magnetic disk of a remote computer. In such a scenario, the remote computer loads the instructions into main memory and sends the instructions over a telephone line using a modem. A modem of a local system receives the data on the telephone line and uses an infrared transmitter to convert the data to an infrared signal and transmit the infrared signal to a portable computing device, such as a personal digital assistant (PDA) or a laptop. An infrared detector on the portable computing device receives the information and instructions borne by the infrared signal and places the data on a bus. The bus conveys the data to main memory, from which a processor retrieves and executes the instructions. The instructions received by main memory can optionally be stored on storage device either before or after execution by processor.

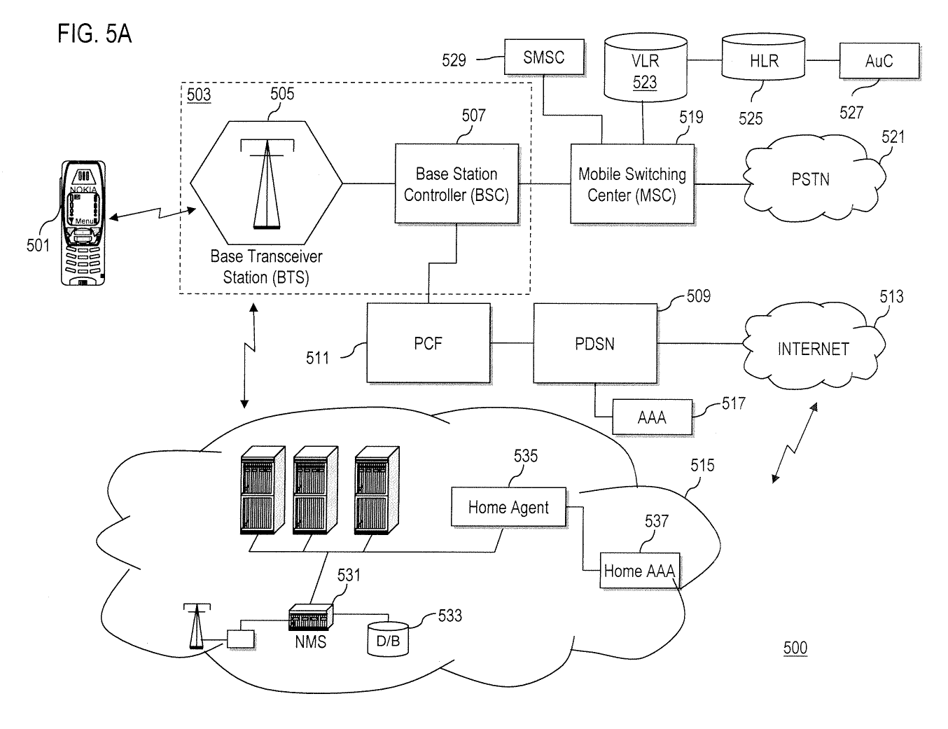

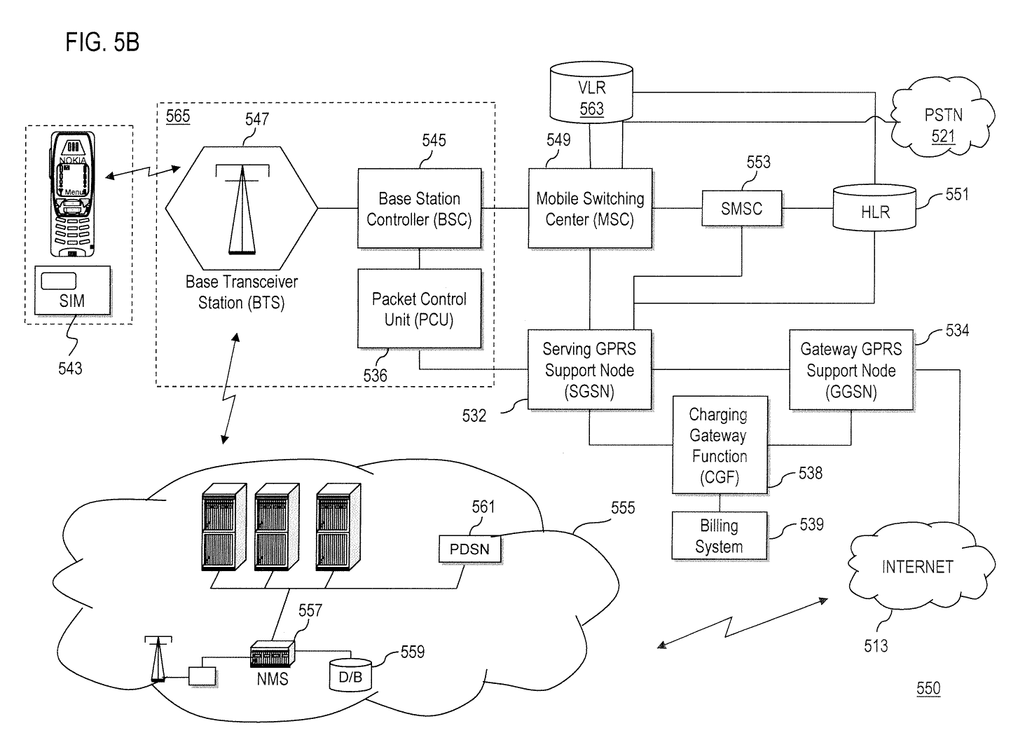

FIGS. 5A and 5B are diagrams of different cellular mobile phone systems capable of supporting various embodiments of the invention. FIGS. 5A and 5B show exemplary cellular mobile phone systems each with both mobile station (e.g., handset) and base station having a transceiver installed (as part of a Digital Signal Processor (DSP)), hardware, software, an integrated circuit, and/or a semiconductor device in the base station and mobile station). By way of example, the radio network supports Second and Third Generation (2G and 3G) services as defined by the International Telecommunications Union (ITU) for International Mobile Telecommunications 2000 (IMT-2000). For the purposes of explanation, the carrier and channel selection capability of the radio network is explained with respect to a cdma2000 architecture. As the third-generation version of IS-95, cdma2000 is being standardized in the Third Generation Partnership Project 2 (3GPP2).

A radio network 500 includes mobile stations 501 (e.g., handsets, terminals, stations, units, devices, or any type of interface to the user (such as “wearable” circuitry, etc.)) in communication with a Base Station Subsystem (BSS) 503. According to one embodiment of the invention, the radio network supports Third Generation (3G) services as defined by the International Telecommunications Union (ITU) for International Mobile Telecommunications 2000 (IMT-2000).

In this example, the BSS 503 includes a Base Transceiver Station (BTS) 505 and Base Station Controller (BSC) 507. Although a single BTS is shown, it is recognized that multiple BTSs are typically connected to the BSC through, for example, point-to-point links. Each BSS 503 is linked to a Packet Data Serving Node (PDSN) 509 through a transmission control entity, or a Packet Control Function (PCF) 511. Since the PDSN 509 serves as a gateway to external networks, e.g., the Internet 513 or other private consumer networks 515, the PDSN 509 can include an Access, Authorization and Accounting system (AAA) 517 to securely determine the identity and privileges of a user and to track each user's activities. The network 515 comprises a Network Management System (NMS) 531 linked to one or more databases 533 that are accessed through a Home Agent (HA) 535 secured by a Home AAA 537.

Although a single BSS 503 is shown, it is recognized that multiple BSSs 503 are typically connected to a Mobile Switching Center (MSC) 519. The MSC 519 provides connectivity to a circuit-switched telephone network, such as the Public Switched Telephone Network (PSTN) 521. Similarly, it is also recognized that the MSC 519 may be connected to other MSCs 519 on the same network 500 and/or to other radio networks. The MSC 519 is generally collocated with a Visitor Location Register (VLR) 523 database that holds temporary information about active subscribers to that MSC 519. The data within the VLR 523 database is to a large extent a copy of the Home Location Register (HLR) 525 database, which stores detailed subscriber service subscription information. In some implementations, the HLR 525 and VLR 523 are the same physical database; however, the HLR 525 can be located at a remote location accessed through, for example, a Signaling System Number 7 (SS7) network. An Authentication Center (AuC) 527 containing subscriber-specific authentication data, such as a secret authentication key, is associated with the HLR 525 for authenticating users. Furthermore, the MSC 519 is connected to a Short Message Service Center (SMSC) 529 that stores and forwards short messages to and from the radio network 500.

During typical operation of the cellular telephone system, BTSs 505 receive and demodulate sets of reverse-link signals from sets of mobile units 501 conducting telephone calls or other communications. Each reverse-link signal received by a given BTS 505 is processed within that station. The resulting data is forwarded to the BSC 507. The BSC 507 provides call resource allocation and mobility management functionality including the orchestration of soft handoffs between BTSs 505. The BSC 507 also routes the received data to the MSC 519, which in turn provides additional routing and/or switching for interface with the PSTN 521. The MSC 519 is also responsible for call setup, call termination, management of inter-MSC handover and supplementary services, and collecting, charging and accounting information. Similarly, the radio network 500 sends forward-link messages. The PSTN 521 interfaces with the MSC 519. The MSC 519 additionally interfaces with the BSC 507, which in turn communicates with the BTSs 505, which modulate and transmit sets of forward-link signals to the sets of mobile units 501.

As shown in FIG. 5B, the two key elements of the General Packet Radio Service (GPRS) infrastructure 550 are the Serving GPRS Supporting Node (SGSN) 532 and the Gateway GPRS Support Node (GGSN) 534. In addition, the GPRS infrastructure includes a Packet Control Unit PCU (536) and a Charging Gateway Function (CGF) 538 linked to a Billing System 539. A GPRS the Mobile Station (MS) 541 employs a Subscriber Identity Module (SIM) 543.

The PCU 536 is a logical network element responsible for GPRS-related functions such as air interface access control, packet scheduling on the air interface, and packet assembly and re-assembly. Generally the PCU 536 is physically integrated with the BSC 545; however, it can be collocated with a BTS 547 or a SGSN 532. The SGSN 532 provides equivalent functions as the MSC 549 including mobility management, security, and access control functions but in the packet-switched domain. Furthermore, the SGSN 532 has connectivity with the PCU 536 through, for example, a Frame Relay-based interface using the BSS GPRS protocol (BSSGP). Although only one SGSN is shown, it is recognized that that multiple SGSNs 531 can be employed and can divide the service area into corresponding routing areas (RAs). A SGSN/SGSN interface allows packet tunneling from old SGSNs to new SGSNs when an RA update takes place during an ongoing Personal Development Planning (PDP) context. While a given SGSN may serve multiple BSCs 545, any given BSC 545 generally interfaces with one SGSN 532. Also, the SGSN 532 is optionally connected with the HLR 551 through an SS7-based interface using GPRS enhanced Mobile Application Part (MAP) or with the MSC 549 through an SS7-based interface using Signaling Connection Control Part (SCCP). The SGSN/HLR interface allows the SGSN 532 to provide location updates to the HLR 551 and to retrieve GPRS-related subscription information within the SGSN service area. The SGSN/MSC interface enables coordination between circuit-switched services and packet data services such as paging a subscriber for a voice call. Finally, the SGSN 532 interfaces with a SMSC 553 to enable short messaging functionality over the network 550.

The GGSN 534 is the gateway to external packet data networks, such as the Internet 513 or other private customer networks 555. The network 555 comprises a Network Management System (NMS) 557 linked to one or more databases 559 accessed through a PDSN 561. The GGSN 534 assigns Internet Protocol (IP) addresses and can also authenticate users acting as a Remote Authentication Dial-In User Service host. Firewalls located at the GGSN 534 also perform a firewall function to restrict unauthorized traffic. Although only one GGSN 534 is shown, it is recognized that a given SGSN 532 may interface with one or more GGSNs 534 to allow user data to be tunneled between the two entities as well as to and from the network 550. When external data networks initialize sessions over the GPRS network 550, the GGSN 534 queries the HLR 551 for the SGSN 532 currently serving a MS 541.

The BTS 547 and BSC 545 manage the radio interface, including controlling which Mobile Station (MS) 541 has access to the radio channel at what time. These elements essentially relay messages between the MS 541 and SGSN 532. The SGSN 532 manages communications with an MS 541, sending and receiving data and keeping track of its location. The SGSN 532 also registers the MS 541, authenticates the MS 541, and encrypts data sent to the MS 541.

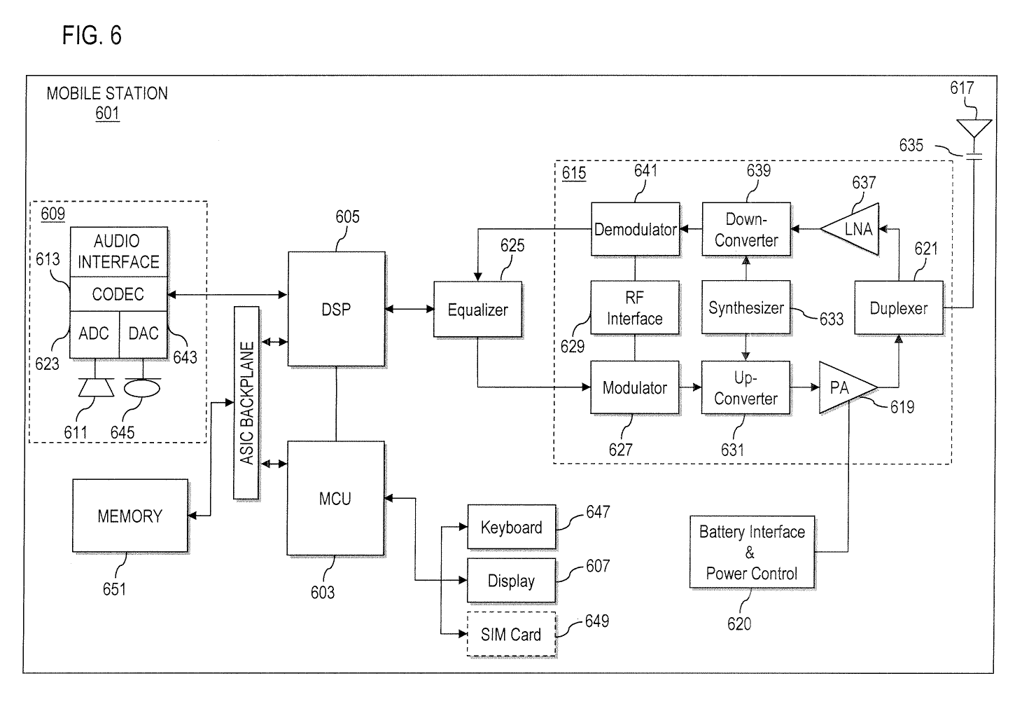

FIG. 6 is a diagram of exemplary components of a mobile station (e.g., handset) capable of operating in the systems of FIGS. 5A and 5B, according to an embodiment of the invention. Generally, a radio receiver is often defined in terms of front-end and back-end characteristics. The front-end of the receiver encompasses all of the Radio Frequency (RF) circuitry whereas the back-end encompasses all of the base-band processing circuitry. Pertinent internal components of the telephone include a Main Control Unit (MCU) 603, a Digital Signal Processor (DSP) 605, and a receiver/transmitter unit including a microphone gain control unit and a speaker gain control unit. A main display unit 607 provides a display to the user in support of various applications and mobile station functions. An audio function circuitry 609 includes a microphone 611 and microphone amplifier that amplifies the speech signal output from the microphone 611. The amplified speech signal output from the microphone 611 is fed to a coder/decoder (CODEC) 613.

A radio section 615 amplifies power and converts frequency in order to communicate with a base station, which is included in a mobile communication system (e.g., systems of FIG. 5A or 5B), via antenna 617. The power amplifier (PA) 619 and the transmitter/modulation circuitry are operationally responsive to the MCU 603, with an output from the PA 619 coupled to the duplexer 621 or circulator or antenna switch, as known in the art. The PA 619 also couples to a battery interface and power control unit 620.

In use, a user of mobile station 601 speaks into the microphone 611 and his or her voice along with any detected background noise is converted into an analog voltage. The analog voltage is then converted into a digital signal through the Analog to Digital Converter (ADC) 623. The control unit 603 routes the digital signal into the DSP 605 for processing therein, such as speech encoding, channel encoding, encrypting, and interleaving. In the exemplary embodiment, the processed voice signals are encoded, by units not separately shown, using the cellular transmission protocol of Code Division Multiple Access (CDMA), as described in detail in the Telecommunication Industry Association's TIA/EIA/IS-95-A Mobile Station-Base Station Compatibility Standard for Dual-Mode Wideband Spread Spectrum Cellular System; which is incorporated herein by reference in its entirety.

The encoded signals are then routed to an equalizer 625 for compensation of any frequency-dependent impairments that occur during transmission though the air such as phase and amplitude distortion. After equalizing the bit stream, the modulator 627 combines the signal with a RF signal generated in the RF interface 629. The modulator 627 generates a sine wave by way of frequency or phase modulation. In order to prepare the signal for transmission, an up-converter 631 combines the sine wave output from the modulator 627 with another sine wave generated by a synthesizer 633 to achieve the desired frequency of transmission. The signal is then sent through a PA 619 to increase the signal to an appropriate power level. In practical systems, the PA 619 acts as a variable gain amplifier whose gain is controlled by the DSP 605 from information received from a network base station. The signal is then filtered within the duplexer 621 and optionally sent to an antenna coupler 635 to match impedances to provide maximum power transfer. Finally, the signal is transmitted via antenna 617 to a local base station. An automatic gain control (AGC) can be supplied to control the gain of the final stages of the receiver. The signals may be forwarded from there to a remote telephone which may be another cellular telephone, other mobile phone or a land-line connected to a Public Switched Telephone Network (PSTN), or other telephony networks.

Voice signals transmitted to the mobile station 601 are received via antenna 617 and immediately amplified by a low noise amplifier (LNA) 637. A down-converter 639 lowers the carrier frequency while the demodulator 641 strips away the RF leaving only a digital bit stream. The signal then goes through the equalizer 625 and is processed by the DSP 605. A Digital to Analog Converter (DAC) 643 converts the signal and the resulting output is transmitted to the user through the speaker 645, all under control of a Main Control Unit (MCU) 603—which can be implemented as a Central Processing Unit (CPU) (not shown).

The MCU 603 receives various signals including input signals from the keyboard 647. The MCU 603 delivers a display command and a switch command to the display 607 and to the speech output switching controller, respectively. Further, the MCU 603 exchanges information with the DSP 605 and can access an optionally incorporated SIM card 649 and a memory 651. In addition, the MCU 603 executes various control functions required of the station. The DSP 605 may, depending upon the implementation, perform any of a variety of conventional digital processing functions on the voice signals. Additionally, DSP 605 determines the background noise level of the local environment from the signals detected by microphone 611 and sets the gain of microphone 611 to a level selected to compensate for the natural tendency of the user of the mobile station 601.

The CODEC 613 includes the ADC 623 and DAC 643. The memory 651 stores various data including call incoming tone data and is capable of storing other data including music data received via, e.g., the global Internet. The software module could reside in RAM memory, flash memory, registers, or any other form of writable storage medium known in the art. The memory device 651 may be, but not limited to, a single memory, CD, DVD, ROM, RAM, EEPROM, optical storage, or any other non-volatile storage medium capable of storing digital data.

An optionally incorporated SIM card 649 carries, for instance, important information, such as the cellular phone number, the carrier supplying service, subscription details, and security information. The SIM card 649 serves primarily to identify the mobile station 601 on a radio network. The card 649 also contains a memory for storing a personal telephone number registry, text messages, and user specific mobile station settings.

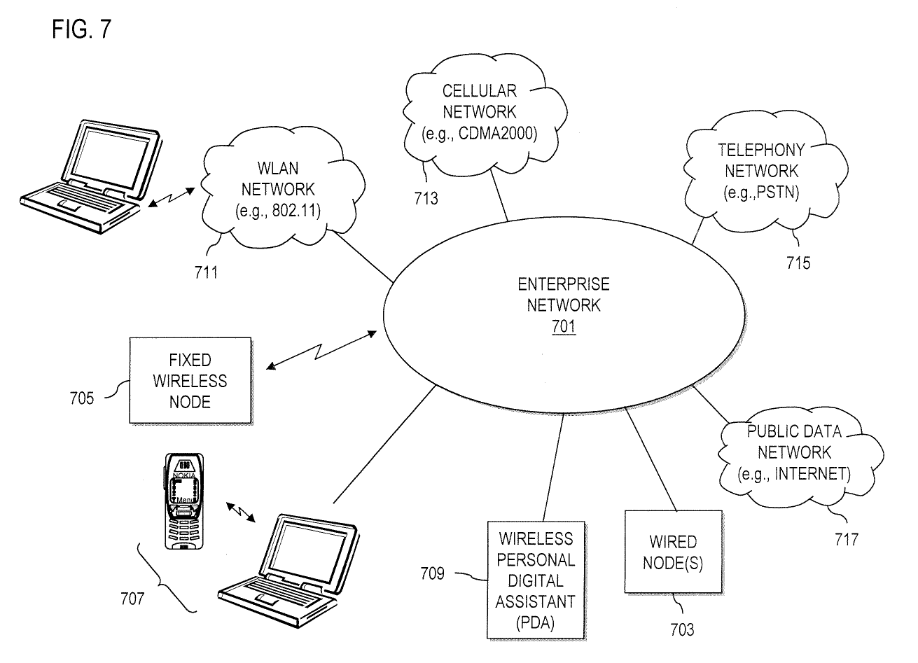

FIG. 7 shows an exemplary enterprise network, which can be any type of data communication network utilizing packet-based and/or cell-based technologies (e.g., Asynchronous Transfer Mode (ATM), Ethernet, IP-based, etc.). The enterprise network 701 provides connectivity for wired nodes 703 as well as wireless nodes 705-709 (fixed or mobile), which are each configured to perform the processes described above. The enterprise network 701 can communicate with a variety of other networks, such as a WLAN network 2311 (e.g., IEEE 802.11), a cdma2000 cellular network 713, a telephony network 716 (e.g., PSTN), or a public data network 717 (e.g., Internet).

While the invention has been described in connection with a number of embodiments and implementations, the invention is not so limited but covers various obvious modifications and equivalent arrangements, which fall within the purview of the appended claims. Although features of the invention are expressed in certain combinations among the claims, it is contemplated that these features can be arranged in any combination and order.

### APPENDIX

### Event Request

The Event Request element contains a request to the receiving STA to perform the specified event action. The format of the Event Request element is shown in the Table 10.

TABLE 10
Event Request Format

| | | | | | Event |
|---|---|---|---|---|---|
| Format | Element ID | Length | Event Token | Event Type | Request |
| Length | 1 | 1 | 1 | 1 | variables |
| (Octets) | | | | | |

The Element ID field is equal to the Event Request value in Table 4. The value of the Length field is variable and depends on the length of the Event Request field. The value of the Length field is 2. The Event Token field is set to a number that is unique among the Event Request elements sent to each destination MAC address for which a corresponding Event Report element has not been received. The Event Type field is set to a number that identifies the type of event request. The Event Types are shown in Table 11.

TABLE 11
Event Types

| Name | Event Type |
|---|---|
| Transition | 0 |
| RSNA | 1 |
| Peer-to-Peer Link | 2 |
| System Log (Syslog) | 3 |
| Reserved | 4-255 |

The Event Request field contains the event request corresponding to the Event Type. The Event Request field is not present when requesting a Syslog report. The Event Request element is included in an Event Request frame. The Event Request field corresponding to the Transition event request contains zero or more Transition Event Request sub-elements. The Transition Event Request sub-elements are defined to have a common general format consisting of a 1 octet Sub-element ID field, a 1 octet length field, and a variable length sub-element specific information field. The set of valid Transition Event Request sub-elements is defined in Table 12.

TABLE 12
Set of Valid Transition Event Request Sub-Elements

| Transition Event | |
|---|---|
| Request Sub-element | Sub-element ID |
| Target BSSID Transition | 0 |
| Source BSSID Transition | 1 |
| Transition Time | 2 |
| Transition Result | 3 |
| Frequent Transition | 4 |
| Reserved | 5-255 |

The Event Request field 1009 corresponding to an RSNA event request contains zero or more RSNA Event Request sub-elements. The RSNA Event Request sub-elements are defined to have a common general format consisting of a 1 octet Sub-element ID field, a 1 octet length field, and a variable length sub-element specific information field. The set of valid RSNA Event Request sub-elements is defined in Table 13.

TABLE 13
The set of valid RSNA Event Request sub-elements

| RSNA Event Request Sub-element | Sub-element ID |
|---|---|
| Target BSSID RSNA | 0 |
| Authentication Type | 1 |
| EAP Method | 2 |
| RSNA Result | 3 |
| Reserved | 4-255 |

The Event Request field corresponding to Peer-to-Peer Link event request contains zero or more Peer-to-Peer Link Event Request sub-elements. The Peer-to-Peer Link Event Request sub-elements are defined to have a common general format consisting of a 1 octet Sub-element ID field, a 1 octet length field, and a variable length sub-element specific information field. The set of valid Peer-to-Peer Link Event Request sub-elements is defined in Table 14.

TABLE 14
Set of Valid Peer-to-Peer Link Event Request Sub-Elements

| Peer-to-Peer Link Event | |
|---|---|
| Request Sub-element | Sub-element ID |
| Peer STA Address | 0 |
| Channel Number | 1 |
| Reserved | 2 |

### Event Report

The Event Report element contains an event report. The format of the Event Report element is shown in Table 15.

TABLE 15
Event Report Format

| | | | Element | | Event | Event | Event |
|---|---|---|---|---|---|---|---|
| Format | Element ID | Length | Token | Event Type | Status | Timestamp | Report |
| Length | 1 | 1 | 1 | 1 | 1 | 8 | variable |
| (Octet) | | | | | | | |

The Element ID field is equal to the Event Report value in Table 4. The value of the Length field is variable and depends on the length of the Event Report field. The minimum value of the Length field is 3. The Event Token field is set to the Event Token in the corresponding Event Request element. If the Event Report element is being sent autonomously then the Event Token is set to 0. The Event Type field is set to a number that identifies the type of event report. The Event Types that have been allocated for event reports are shown in Table 16.

TABLE 16
Event Type Definitions For Event Requests and Reports

| Name | Event Type |
|---|---|
| Transition | 0 |
| RSNA | 1 |
| Peer-to-Peer to Link | 2 |
| System Log (Syslog) | 3 |
| Reserved | 4-255 |

### The Event Status field is set to a value in Table 17, indicating the STA's response to the Event Request indicated by the Dialog Token.

TABLE 17
Event Status

| Event Status | Description |
|---|---|
| 0 | Successful |
| 1 | Fail |
| 2 | Refused |
| 3 | Incapable |
| 4-255 | Reserved |

The Event Timestamp and Event Report fields are only present when the Status field is set to 0. The Event Timestamp field is set to the value of the STA TSF timer when the event was logged. The Event Report field contains the specification of the event report and the Event Report element is included in an Event Report frame.

### Diagnostic Request Element

The Diagnostic Request element contains a request that the receiving STA undertake the specified diagnostic action. The format of the Diagnostic Request element is shown in Table 18.

TABLE 18
Diagnostic Request Format

| | | | | | Diagnostic |
|---|---|---|---|---|---|
| | Element | | Diagnostic | Diagnostic | Information |
| Format | ID | Length | Token | Request Type | Sub-elements |
| Length | 1 | 1 | 1 | 1 | variable |
| (Octet) | | | | | |

The Element ID field is equal to the Diagnostic Request value in Table 4. The value of the Length field is variable and depends on the length of the Diagnostic Information Sub-elements field. The minimum value of the Length field is 2 (based on a minimum length for the Diagnostic Information Sub-elements field of 0 octets). The Diagnostic Token field is set to a number that is unique among the Diagnostic Request elements sent to each destination MAC address for which a corresponding Diagnostic Report element has not been received. The Diagnostic Request Type field is set to a number that identifies a type of diagnostic request. The defined Diagnostic Request Types are shown in Table 19. The Diagnostic Information Sub-elements field contains zero or more diagnostic information sub-elements depending on the specific Diagnostic Request Type.

TABLE 19
Diagnostic Request Type definitions

| Name | Request Type Value |
|---|---|
| Manufacturer Information STA Report | 0 |
| Operating Parameters STA Report | 1 |
| Capabilities STA Report | 2 |
| Configuration Profile | 3 |
| IEEE 802.11 Authentication Diagnostic | 4 |
| Association Diagnostic | 5 |
| IEEE 802.1X Authentication | 6 |
| Diagnostic | |
| Reserved | 7-255 |

The Manufacturer Information STA Report (Request Type=0), Operating Parameters STA Report (Request Type=1), Capabilities STA Report (Request Type=2) and Configuration Profile (Request Type=3) Diagnostic Request elements carry no Diagnostic Information sub-elements. The Diagnostic Request element is included in a Diagnostic Request frame.

### Diagnostic Report

The Diagnostic Report element contains a Diagnostic report. The format of the Diagnostic Report element is shown in Table 20.

TABLE 20
Diagnostic Report Format

| | | | | Diag- | | Diagnostic |
|---|---|---|---|---|---|---|
| | | | Diag- | nostic | | Information |
| | Element | | nostic | Report | Diagnostic | Sub- |
| Format | ID | Length | Token | Type | Status | elements |
| Length | 1 | 1 | 1 | 1 | 1 | variable |
| (Octet) | | | | | | |

The Element ID field is equal to the Diagnostic Report value in Table 4. The value of the Length field is variable and depends on the length of the Diagnostic Information Sub-elements field. The minimum value of the Length field is 3. The Diagnostic Token field is set to the Diagnostic Token in the corresponding Diagnostic Request element. The Diagnostic Report Type field is set to a number that identifies the Diagnostic report. Those Diagnostic Report Types are shown in Table 16. The Diagnostic Status field is set to a value in Table 15, indicating the STA's response to the Diagnostic Request indicated by the Dialog Token. The Diagnostic Information Sub-elements field contains the results of the diagnostic request. The Diagnostic Report element is included in a Diagnostic Report frame.

### Presence Parameters

The Presence Parameters information element is used for presence and location services. The format of this information element is shown in Table 21.

TABLE 21
Presence Parameters Format

| | | | Presence Sub- |
|---|---|---|---|
| Format | Element ID | Length | elements |
| Length (Octet) | 1 | 1 | variable |

The Element ID field is equal to the Presence Parameters value in Table 4. The value of the Length field is variable and depends on the length of the Presence Sub-elements field. The Presence Sub-elements field contains one or more Presence sub-elements described in Table 22.

TABLE 22
Presence Sub-elements

| Identifier | Sub-element Name |
|---|---|
| 1 | Presence Indication Parameters |
| 2 | Presence Indication Channels |
| 3 | Presence Request Options |
| 4 | Presence Status |
| 5 | Location Service Parameters |
| 6 | Radio Information |
| 7 | Timing Measurements |
| 8 | Motion |
| 9 | Location Descriptor |
| 10 | Location Data |
| 11 | Location Source Identifier |
| 12-220 | Reserved |
| 221 | Vendor Specific |
| 222-255 | Reserved |

The Presence Parameters element is included in Beacon frames, Probe Response frames, Association Request frames, Reassociation Request frames, Presence Request frames, Presence Response frames, Presence Configuration Request frames, and Presence Configuration Response frames. Of the Presence sub-elements listed in Table 4, Table below lists the sub-elements that are excluded from the Presence Parameters information element when the Presence Parameters information element is sent as part of a Beacon or Probe Response frame.

TABLE 23
Sub-elements excluded in Beacon or Probe Response frames

| Identifier | Sub-element Name |
|---|---|
| 4 | Presence Status |
| 8 | Motion |

### Multiple BSSID

The format of the Multiple BSSID element is shown in Table 24.

TABLE 24
Multiple BSSID Format

| | | | Max BSSID | Non-Transmitted |
|---|---|---|---|---|
| Format | Element ID | Length | Indicator | BSSID Profile |
| Length | 1 | 1 | 1 | variable |
| (Octets) | | | | |

The Element ID field is equal to the Multiple BSSID value in Table 4. The value of the Length field is the length of the Non-Transmitted BSSID profile (variable)+1. More than one Multiple BSSID elements may be included in a Beacon frame. The AP determines the number of Multiple BSSID elements. The AP does not fragment a Non-Transmitted BSSID Profile element across two Multiple BSSID elements. The value of the Max BSSID Indicator field is n, where 2n is the maximum number of BSSIDs supported by the AP, including the transmitted BSSID. The actual number of SSIDs supported by the AP is not explicitly signaled. The non-transmitted BSSID (i) value corresponding to the ith BSSID profile (indicated by the BSSID index) is derived from the transmitting AP's BSSID (AP_BSSID) as follows: BSSID(i)=(AP_BSSID modified to set the n LSBs to zero)|((n LSBs of AP_BSSID)+i) mod 2n), where, (|) indicates the OR operation.

The Non-Transmitted BSSID Profile field includes the Capabilities field followed by a variable number of information elements, defined as follows:—The Timestamp, Beacon Interval, DS Parameter Set, FH Parameter Set, IBSS Parameter Set, Country, FH Parameters, FH Pattern Table, Channel Switch Assignment, Extended Channel Switch Announcement, Supported Regulatory Classes, IBSS DFS, and ERP Information elements are not included in the Non-Transmitted BSSID Profile field; the values of these elements for each nontransmitted BSSID are always the same as the corresponding transmitted BSSID element values. The Multiple BSSID element is not included in the Non-Transmitted BSSID Profile field. The SSID and Multiple BSSID-Index elements are included in the Non-Transmitted BSSID Profile field. The FBMS Descriptor element is included in the Non-Transmitted BSSID Profile field if the Multiple BSSID element is included in a Beacon frame and if the TIM field indicates there are buffered multicast frames for this non-transmitted BSSID. The Multiple BSSID element is included in Beacon frames and Probe Response frames.

### Multiple SSID

The format of the Multiple SSID element is shown in Table 25.

TABLE 25
Multiple SSID Format

| Format | Element ID | Length | SSID List |
|---|---|---|---|
| Length (Octet) | 1 | 1 | variable |

The Element ID field is equal to the Multiple SSID value in Table 4. The value of Length field is the length of the SSID list (variable) in octets. The SSID List field is a list of the SSID elements for which the STA is requesting information. The Multiple SSID element is included in Probe Request frames.

### Multiple BSSID-Index

The format of the Multiple BSSID-Index element is shown in Table 26.

TABLE 26
Multiple BSSID-index format

| | | | BSSID | DTIM | DTIM |
|---|---|---|---|---|---|
| Format | Element ID | Length | Index | Period | Count |
| Length | 1 | 1 | 1 | 1 | 1 |
| (Octet) | | | | | |

The Element ID field is equal to the Multiple BSSID-Index value in Table 4. The value of Length field is one octet when the Multiple BSSID-Index element is included in the Probe Response frame. The BSSID Index field is a value between 1 and 2n−1, which identifies the non-transmitted BSSID. The DTIM Period field is the DTIM period field for the BSSID. This field is not present when the Multiple BSSID-Index element is included in the Probe Response frame. The DTIM Count field is the DTIM count field for the BSSID. This field is not present when the Multiple BSSID-Index element is included in the Probe Response frame. The Multiple BSSID-Index element is included in Multiple BSSID elements. The use of the Multiple BSSID element and frames.

### FBMS Descriptor

The FBMS Descriptor element defines information about Broadcast/Multicast frames buffered in an AP. It may be present in the Beacon frames if dot11WirelessManagementImplemented is true and if the AP supports FBMS. If there is no active FBMS stream then the FBMS Descriptor element is not included in the Beacon frame. The format of the FBMS Descriptor element is shown in Table 27.

TABLE 27
FBMS Descriptor Format

| | | | | Counters | |
|---|---|---|---|---|---|
| | | | | One or more | |
| | | | | FBMS | |
| | | | Number of | Counters | One or more |
| | Element | | FBMS | FBMS | FBMSIDS |
| Format | ID | Length | Counters | Counters | FBMSIDs |
| Length | 1 | 1 | 1 | n | m |
| (Octet) | | | | | |

The Element ID field is equal to the FBMS Descriptor value in Table 4. The Length field is set to 1+n+m, where n is the number of FBMS Counters present and m indicates the number of 1-octet FBMSIDs present in the information element. The FBMS Counters field contains one or more FBMS Counters. The format of the FBMS Counter is shown in Table 28. When there are one or more active FBMS streams, then at least one FBMS counter must be present in the FBMS Descriptor element. Optionally, from 2 to a maximum of eight counters are permitted. The FBMS counters are used by the non-AP STA to identify the DTIM beacon after which broadcast/multicast frames assigned to a particular delivery interval are transmitted.

TABLE 28
FBMS Counter Format

Counters

| | B0-B2 | B3-B7 |
|---|---|---|
| Format | FBMS Counter ID | Current Count |
| Length (Octet) | 3 | 5 |

The FBMS Counter ID field includes three least significant bits of the FBMS Counter ID assigned in the FBMS Response element. The Current Count field indicates how many DTIM Beacon (including the current one) frames appear before the next DTIM Beacon frame after which the broadcast/multicast frames assigned to a particular delivery interval are scheduled to be transmitted. The FBMSIDs field contains one or more FBMSIDs. The FBMSID is a 1-octet identifier. Inclusion of an FBMSID indicates the AP has buffered frames for the corresponding broadcast/multicast stream which is scheduled for transmission immediately after the DTIM Beacon frame. The FBMS Descriptor element is included in Beacon frames.

### FBMS Request Element

The FBMS Request element defines information about the Broadcast/Multicast frames being requested by the non-AP STA. The format of FBMS Request element is shown in Table 29.

TABLE 29
FBMS Request Format

| | | | | | Counters |
|---|---|---|---|---|---|
| | | | | | One or more |
| | | | | | FBMS |
| | | | | Multicast | subelements |
| | Element | | FBMS Stream | Element | FBMS |
| Format | ID | Length | ID | Count | Subelement |
| Length | 1 | 1 | 1 | 1 | variable |
| (Octet) | | | | | |

The Element ID field is set to the FBMS Request value in Table 4. The Length field is set to 2+n, where n indicates the total length of all FBMS Sub-elements contained in the element. The FBMS Stream ID field contains a unique identifier for a FBMS stream, assigned by the AP upon original subscription. If this is a new request then the FBMS Stream ID value is set to 0. Otherwise, the FBMS Stream ID value is set to the value assigned in the FBMS Response element. The FBMS Stream ID is fixed during the lifetime of the FBMS Stream. The Multicast Element Count indicates the number of the FBMS Sub-elements present. The format of the FBMS sub-element is shown in the Table 30.

TABLE 30
FBMS Sub-element Format

| | Counters | | | |
|---|---|---|---|---|
| | One or more | | | |
| | Optional TCLAS | | | |
| | Element | TCLAS | | |
| | TCLAS | Processing | Delivery | Multicast |
| Format | Elements | Element | Interval | Rate |
| Length (Octet) | variable | 3 | 2 | 1 |

The TCLAS Elements field contains one or more TCLAS information elements to classify the Broadcast/Multicast stream. The TCLAS Processing Element field is optionally present and defines how multiple TCLAS information elements are processed. The Delivery Interval field defines the number of DTIMs that the stream is transmitted at. The default value is 1. The value set to 0 indicates that requesting Non-AP STA does not use the FBMS sub-element anymore. The Multicast Rate field specifies the highest data rate, in 0.5 Mb/s units, at which the STA can reliably receive multicast frames. If no value is provided by the STA, this field is set to 0. The FBMS Request element is included in FBMS Request frames, Association Request frames, and Reassociation Request frames.

### FBMS Response Element

The FBMS Response element defines information about the broadcast/multicast status. The format of the FBMS Response element is shown in Table 30.

TABLE 31
FBMS Response Format

| | | | | Counters |
|---|---|---|---|---|
| | | | | One or more |
| | | | | FBMS Status |
| | | | | Sub-element |
| | | | FBMS Stream | FBMS Status |
| Format | Element ID | Length | ID | Sub-elements |
| Length (Octet) | 1 | 1 | 1 | variable |

The Element ID field is set to the FBMS Response value in Table 4. The Length field is set to 1+n, where n indicates the total length of all FBMS Sub-elements contained in the element. The FBMS Stream ID field is assigned by the AP for a particular FBMS stream, and provides a unique identifier for this stream within the BSS. The FBMS Status Sub-elements field contains one or more FBMS Status sub-elements. The format of the FBMS Status sub-element is shown in the Table 32.

TABLE 32
FBMS Status Format

| | | | | | | | Multicast |
|---|---|---|---|---|---|---|---|
| | Element | Delivery | | FBMS | Multicast | Multicast | Diagnostic |
| Format | Status | Interval | FBMSID | Counter | Rate | Address | Interval |
| Length | 1 | 1 | 1 | 1 | 1 | 6 | 4 |
| (Octet) | | | | | | | |

The Element Status field indicates the status of the AP responding to the STA's requested delivery interval, as indicated in Table 33. The Delivery Interval field defines the number of DTIMs at which the stream is transmitted. The value set to 0 indicates that requesting Non-AP STA does not use this FBMS sub-element anymore. The FBMSID field is assigned by the AP and provides a unique identifier for this stream within the BSS. The format of the FBMS Counter field is shown in the Table 27. The Multicast Rate field specifies the data rate in 0.5 Mb/s units to be used for the multicast service. If the value of the Multicast Rate field is set to 0 then the data rate is undefined. The Multicast Address field specifies the multicast MAC address for the multicast service. The Multicast Diagnostic Interval field specifies the maximum number of beacon intervals for which the STA keeps multicast service traffic counts. The FBMS Response element is included in FBMS Response frames Association Response frames, and Reassociation Response frames.

TABLE 33
Element Status Definition

| Value | Description |
|---|---|
| 0 | Accept |
| 1 | Deny, due to malformed request or ambiguous classifier. |
| 2 | Deny, due to lack of resources on AP. |
| 3 | Deny, due to requested classifier(s) matching 2 or more |
| | existing streams on different intervals |
| 4 | Deny, by policy, requested stream is not permitted to |
| | participate in FBMS |
| 5 | Override, due to existing stream with different delivery |
| | interval |
| 6 | Override, due to policy limits on AP. |
| 7 | Override, due to AP changed the delivery interval. |
| 8 | Override, due to AP multicast rate policy |
| 9 | Terminate, due to AP policy change |
| 10 | Terminate, due to lack of resources of AP |
| 11 | Terminate, due to other FBMS stream with higher priority |
| 12-255 | Reserved |

### Traffic Generation Element

The Traffic Generation element provides information about types of traffic generated by a STA. The format of the Traffic Generation element is shown in Table 34.

TABLE 34
Traffic Generation Format

| | | | Traffic Generation |
|---|---|---|---|
| Format | Element ID | Length | Flags |
| Length (Octet) | 1 | 1 | 1 |

The Element ID field is set to the Traffic Generation value in Table 4. The value of the Length field is set to 1. The format of Traffic Generation Flags field is defined in Table 35.

TABLE 35
Traffic Generation Flags Definition

| Bit (s) | Description |
|---|---|
| 0 | UP 1 Traffic |
| 1 | UP 2 Traffic |
| 2 | UP 3 Traffic |
| 3 | UP 4 Traffic |
| 4 | UP 5 Traffic |
| 5 | UP 6 Traffic |
| 6 | UP 7 Traffic |
| 7 | UP 8 Traffic |

Each bit in the Traffic Generation Flags field serves as a flag for one of the eight user priorities. The bit is set to 1 to indicate the expectation of generating traffic belonging to the corresponding user priority (UP). The bit is set to 0 to indicate that such an expectation does not exist. The Traffic Generation element is included in Association Request frames and Reassociation Request frames.

### AC Station Count

The format of the AC Station Count element is shown in Table 36.

TABLE 36
AC Station Count Format

| | | | Station | |
|---|---|---|---|---|
| | | | Count | Station Count |
| Format | Element ID | Length | Bitmask | List |
| Length (Octet) | 1 | 1 | 1 | 2 × (total number |
| | | | | of nonzero bits in |
| | | | | Station Count |
| | | | | Bitmask) |

The Element ID field is set to the AC Station Count value in Table 4. The value of the Length field is set to 1+2*N, where N equals the total number of nonzero bits in Station Count Bitmask. The Station Count Bitmask field indicates the AC values that have Station Count specified in the following Station Count List. The format of the Station Count Bitmask is defined in Table 37. The bit set to 1 indicates that the Station Count for the corresponding access category is present in the Station Count List field. The bit set to 0 indicates that the Station Count for the corresponding access category is not present in the Station Count List field.

TABLE 37
Station Count Bitmask Definition

| Bit (s) | Station Count Reported |
|---|---|
| 0 | AC 0 (VO) |
| 1 | AC 1 (VI) |
| 2 | AC 2 (BE) |
| 3 | AC 3 (BK) |
| 4-7 | Reserved |

The Station Count List comprises a sequence of Station Count fields corresponding to the nonzero bits in the Station Count Bitmask field. The Station Count field is 2 octets long and contains an unsigned integer that specifies the number of QoS STAs that are currently associated with the QoS AP for the corresponding AC. The Station Count field value can be obtained in a number of ways including the use of Traffic Generation element values of QoS STAs that are associated with the QoS AP. The field is used by non-AP QoS STAs to transition to a QoS AP with potentially higher throughput and QoS effectiveness. The AC Station Count element is included in Probe Response frames

### BSS Max Idle Period

The BSS Max Idle Period element contains the time period a non-AP STA can refrain from transmitting frames to the AP before the AP disassociates the STA. The format of the BSS Max Idle Period element is shown in Table 38.

TABLE 38
BSS Max Idle Period Format

| Format | Element ID | Length | Max Idle Period | Idle Options |
|---|---|---|---|---|
| Length (Octet) | 1 | 1 | 2 | 1 |

The Element ID field is set to the BSS Max Idle Period value in Table 4. The minimum value of the Length field is 3. The Max Idle Period field indicates the number of 1000 TUs that pass before an AP disassociates an inactive non-AP STA. A non-AP STA is considered inactive if the AP has not received a frame of a frame exchange sequence initiated by the STA for a time period equal to or greater than the time specified by the Max Idle Period field value. The Idle Options field is a bit-field indicating the options associated with the BSS Max Idle capability. The Idle Options field is shown in the following Table 39.

TABLE 39
Idle Option Field Format

Counter

| | B0 | |
|---|---|---|
| | Protected Keep-Alive | B1-B7 |
| Format | Required | Reserved |
| Length (Octet) | 1 | 7 |

The Protected Keep-Alive Required bit set to 1 indicates that the STA must send an RSN protected frame to the AP to reset the Idle Timer at the AP for the STA. If the Protected Keep-Alive Required bit is set to 0, the STA sends either an unprotected or a protected frame to the AP to reset the Idle Timer at the AP. The BSS Max Idle Period element is included in Association Response frames and Reassociation Response frames.

### TFS Request Element

The TFS Request element defines information about the traffic filters that are enabled at the AP for the requesting non-AP STA. The format of the TFS Request element is defined in Table 40.

TABLE 40
TFS Request Format

| | | | | | | Counter |
|---|---|---|---|---|---|---|
| | | | | | | One or more |
| | | | | | | TFS |
| | | | | TFS | TFS Sub- | subelement |
| | Element | | | Action | element | TFS |
| Format | ID | Length | TFS ID | Code | Count | Subelements |
| Length | 1 | 1 | 1 | 1 | 1 | variable |
| (Octet) | | | | | | |

The Element ID field is equal to the TFS Request value in Table 4. The Length field is set to 3+n, where n indicates the total length of all TFS Subelements contained in the element. The TFS ID field indicates a unique ID for the set of traffic filters specified in the TFS subelements. The TFS Action Code field is a bit-field. It defines the actions taken at the AP when a frame matches a traffic filter. The functions of the bits in this field are shown in Table 41.

TABLE 41
TFS Action Code field values

| Bit | Information | Notes |
|---|---|---|
| 0 | Delay | Setting this bit to 1 indicates the traffic |
| | | filter is to be deleted when a frame |
| | | matches the traffic filter. A value of 0 for |
| | | this bit indicates no deletion of the |
| | | traffic filter |
| 1 | Notify | Setting this bit to 1 indicates the STA is to |
| | | be sent a TFS Notify frame when a frame |
| | | matches the traffic filter. Setting this bit to |
| | | 0 indicates the AP does not send a TFS |
| | | Notify frame to the requesting STA |
| 2-7 | Reserved | All other bits are reserved, and are set to 0 |
| | | on transmission and ignored on reception |

The TFS Sub-element Count field indicates the number of the TFS Subelements present. The TFS Subelements field contains one or more TFS subelements. The TFS sub-element contains one or more TCLAS information elements and zero or one TCLAS Processing information element, as shown in the Table 42.

TABLE 42
TFS Sub-element Count Format

| | | | Counter | |
|---|---|---|---|---|
| | | | One or more | |
| | | | TCLS Elements | TCLAS |
| | Sub-element | | TCLAS | Processing |
| Format | ID | Length | Elements | Element |
| Length (Octet) | 1 | 1 | variable | 3 |

The Sub-element ID field uniquely identifies this sub-element to be the TFS subelement. The value of this field is 1. The value of the Length field is the sum of the lengths of the TCLAS element(s) plus the optional TCLAS Processing element, if present. The TCLAS Elements field contains one or more TCLAS information elements to specify the traffic filter. The TCLAS Processing Element field is optionally present and defines how multiple TCLAS information elements are processed. The TFS Request element is included in TFS Request frames, Sleep Mode Request frames and Reassociation Request frames.

### TFS Response Element

The TFS Response element defines information about the status of the requested traffic filter. The format of the TFS Response element is defined in Table 43.

TABLE 43
TFS Response Format

| | | | Counter |
|---|---|---|---|
| | | | One or more TFS |
| | | | Status Sub-elements |
| | | | TFS Status Sub- |
| Format | Element ID | Length | elements |
| Length (Octet) | 1 | 1 | n × 2 |

The Element ID field is equal to the TFS Response value in Table 4. The Length field is set to n×2, where n indicates the total length of all TFS Subelements contained in the element. The TFS Status Sub-element field contains the information as defined in the Table 44.

TABLE 44
TFS Response Format

| Format | TFS Response Status | TFS ID |
|---|---|---|
| Length (Octet) | 1 | 1 |

The TFS Response Status field indicates the status returned by the AP responding to the STA's requested traffic filter, as indicated in Table 45. The TFS ID field indicates the unique ID for the TFS traffic filter set. The TFS Response element is included in TFS Response frames, Sleep Mode Response frames, and Reassociation Response frames.

TABLE 45
TFS Status definition

| Value | Description |
|---|---|
| 0 | Accept |
| 1 | Denied due to malformed request or an |
| | ambiguous classifier |
| 2 | Denied due to the lack of resources on AP |
| 3 | Denied due to requested filter(s) matching |
| | 2 or more existing enabled traffic filters |
| 4 | Denied. By policy, requested traffic filter is |
| | not permitted to participate in TFS |
| 5 | Overridden due to the policy limits on AP |
| 6 | Denied. The AP is unable to perform the |
| | requested action |
| 7 | Overridden due to an alternate or a |
| | duplicate traffic filter set on AP |
| 8-255 | Reserved |

### Sleep Mode Element

The Sleep Mode element is used to enter and exit the sleep mode. The format of the Sleep Mode element is shown in Table 46.

TABLE 46
Sleep Mode Format

| | | | | Sleep Mode | | |
|---|---|---|---|---|---|---|
| | Element | | Action | Response | Update | Sleep |
| Format | ID | Length | Type | Status | Policy | Interval |
| Length | 1 | 1 | 1 | 1 | 1 | 1 |
| (Octet) | | | | | | |

The Element ID field is equal to the Sleep Mode value in Table 4. The value of the Length field is 1 or 3, depending on the value of Action Type.

The Action Type field is set to a number that identifies the type of sleep mode request and response. The Action Types are shown in Table 47.

TABLE 47
Action Type definitions

| Name | Event Type | Length |
|---|---|---|
| Enter Sleep Mode | 0 | 3 |
| Exit Sleep Mode | 1 | 1 |
| Reserved | 2-555 | |

The Sleep Mode Response Status field indicates the status returned by the AP responding to the non-AP STA's sleep mode request as defined in Table 48. This field is valid only if the Sleep Mode element is present in the Sleep Mode Response frame and Reassociation Response frame.

TABLE 48
Sleep Mode Response Status definition

| Value | Description |
|---|---|
| 0 | Enter/Exit Sleep Mode Accept |
| 1 | Denied. The AP is unable to perform |
| | the requested action |
| 2 | Denied temporarily. The AP is unable |
| | to perform the requested action at the |
| | current time. The request can be |
| | submitted again at a later time. |
| 3 | Exit Sleep Mode Accept, GTK/IGTK |
| | update required |
| 4-255 | Reserved |

The Update Policy and Sleep Interval fields are present only if the Action Type field is set to “Enter Sleep Mode”. The Update Policy field indicates the policy for security association updates. The set of valid Update Policy is defined in Table 49.

TABLE 49
Update Policy definitions

| Bit | Information | Notes |
|---|---|---|
| 0 | Reserved | |
| 1 | GTK/IGTK | The GTK/IGTK Update Policy bit set to 1 |
| | Update Policy | indicates that the AP suppresses GTK/IGTK |
| | | updates to STAs that are in Sleep Mode. The |
| | | GTK/IGTK Update Policy bit set to 0 indicates |
| | | that the AP does not suppress GTK/IGTK |
| | | updates to STAs that are in Sleep Mode. |
| 2-7 | Reserved | |

The Sleep Interval field indicates to the AP how often a STA in Sleep Mode wakes to receive Beacon frames, defined as the number of DTIM intervals. The value set to 0 indicates that the requesting Non-AP STA does not wake up at any specific interval. The Sleep Mode element is included in Sleep Mode Request frames, Sleep Mode Response frames, Reassociation Request frames, and Reassociation Response frames.

### TIM Broadcast Request

The TIM Broadcast Request element contains information about the periodic TIM broadcast being requested by the non-AP STA. The format of the TIM Broadcast Request element is shown in Table 50.

TABLE 50
TIM Broadcast Request Format

| | | | TIM Broadcast |
|---|---|---|---|
| Format | Element ID | Length | Interval |
| Length (Octet) | 1 | 1 | 1 |

The Element ID field is equal to the TIM Broadcast Request value in Table 4. The value of the Length field is set to 1. The TIM Broadcast Interval field is set to the number of Beacon Periods between TIM frame transmissions. A value of 0 indicates a request to disable TIM Broadcast for the requesting station. The TIM Broadcast Request element is included in TIM Broadcast Request frames, Association Request frames, and Reassociation Request frames.

### TIM Broadcast Response Element

The TIM Broadcast Response element contains information about the periodic TIM broadcast by the AP. The format of the TIM Broadcast Response element is shown in Table 51.

TABLE 51
TIM Broadcast Response Format

| | | | | TIM | TIM | | |
|---|---|---|---|---|---|---|---|
| | | | | Broadcast | Broadcast | High Rate | Low Rate |
| Format | Element ID | Length | Status | Interval | Offset | TIM Rate | TIM Rate |
| Length | 1 | 1 | 1 | 1 | 2 | 1 | 1 |
| (Octet) | | | | | | | |

The Element ID field is equal to the TIM Broadcast Response value in Table 4. The Length field is set to 6. The Status field indicates the status of the AP responding to the STA's requested delivery interval, as indicated in Table 52.

TABLE 52
Status Field Values

| Field value | Description |
|---|---|
| 0 | Accept |
| 1 | Denied due to malformed request |
| 2 | Overridden due to requested interval too long |
| 3 | Overridden due to lack of resources at the AP |
| 4-255 | Reserved |

For all values of the status field, denied (1) included, the AP includes the values for the current TIM broadcast in the next four fields of the TIM Broadcast Response element. The TIM Broadcast Interval field 1437 contains the number of Beacon Periods between scheduled TIM frame transmissions. A value of 0 indicates that the AP does not transmit TIM frames. The TIM Broadcast Offset field 1439 contains the offset in microseconds relative to the TBTT for which a TIM frame is scheduled for transmission. The field contains a signed integer. The High Rate TIM Rate field 1441 provides an indication of the rate which is used to transmit the high rate TIM frame, in units of 0.5 Mb/s. A value of 0 indicates that the high rate TIM frame is not transmitted. The Low Rate TIM Rate field 1443 provides an indication of the rate which is used to transmit the low rate TIM frame, in units of 0.5 Mb/s. A value of 0 indicates that the low rate TIM frame is not transmitted. The TIM Broadcast Response element is included in TIM Broadcast Response frames, Association Response frames, and Reassociation Response frames.

What is claimed is:

1. A method comprising:
receiving a signal from a terminal configured to utilize a power-save mechanism;
determining state of a multicast or broadcast group for the terminal based on the signal; and
bypassing the power-save mechanism of the terminal if the state is determined to be active to permit transmission of data, which is designated for the multicast or the broadcast group, to the terminal.

2. A method according to claim 1, the method further comprising:
transmitting the data to the terminal over a wireless network.

3. A method according to claim 2, wherein the wireless network is a local area network (LAN) compliant with an Institute of Electrical and Electronic Engineers (IEEE) 802.11 architecture.

4. A method according to claim 2, wherein the terminal is further configured to operate over another wireless network including a cellular network.

5. A method according to claim 1, wherein the terminal is in an inactive state, the method further comprising:
generating a message to specify that the terminal can use the power-save mechanism.

6. An apparatus comprising:
a module configured to receive a signal from a terminal configured to utilize a power-save mechanism, and to determine state of a multicast or broadcast group for the terminal based on the signal,
wherein the module is further configured to bypass the power-save mechanism of the terminal if the state is determined to be active to permit transmission of data, which is designated for the multicast or the broadcast group, to the terminal.

7. An apparatus according to claim 6, the apparatus further comprising:
a transmission module configured to transmit the data to the terminal over a wireless network.

8. An apparatus according to claim 7, wherein the wireless network is a local area network (LAN) compliant with an Institute of Electrical and Electronic Engineers (IEEE) 802.11 architecture.

9. An apparatus according to claim 7, wherein the terminal is further configured to operate over another wireless network including a cellular network.

10. An apparatus according to claim 6, wherein the terminal is in an inactive state, the module is further configured to generate a message to specify that the terminal can use the power-save mechanism.

11. A method comprising:
generating a signal specifying an active state associated with a multicast or broadcast group, the signal being transmitted to an access point; and
avoiding entry into a power-saving mode based on the generated signal or another signal generated by any member of the group specifying an active state for the group.

12. A method according to claim 11, the method further comprising:
receiving data destined for the group from the access point over a wireless network.

13. A method according to claim 12, wherein the wireless network is a local area network (LAN) compliant with an Institute of Electrical and Electronic Engineers (IEEE) 802.11 architecture.

14. A method according to claim 12, further comprising:
generating a message for transmission over another wireless network.

15. A method according to claim 14, wherein the other wireless network includes a cellular network.

16. An apparatus comprising:
a processor configured to generate a signal specifying an active state associated with a multicast or broadcast group, the signal being transmitted to an access point,
wherein entry into a power-saving mode is avoided based on the generated signal or another signal generated by any member of the group specifying an active state for the group.

17. An apparatus according to claim 16, the apparatus further comprising:
a transceiver configured to receive data destined for the group from the access point over a wireless network.

18. An apparatus according to claim 17, wherein the wireless network is a local area network (LAN) compliant with an Institute of Electrical and Electronic Engineers (IEEE) 802.11 architecture.

19. An apparatus according to claim 17, further comprising:
a first transmission module configured to transmit and receive data from the wireless network; and
a second transmission module configured to transmit and receive data from another wireless network.

20. An apparatus according to claim 19, wherein the other wireless network includes a cellular network.
